(19) United States
(12) Patent Application Publication
(10) Pub. No.: US 2026/0281910 A1
(43) Pub. Date: Sep. 17, 2026

(54) METHOD AND APPARATUS FOR TRANSMISSION OF UPLINK SIGNAL IN WIRELESS COMMUNICATION SYSTEM

(71) Applicant: Samsung Electronics Co., Ltd., Gyeonggi-do (KR)

(72) Inventors: Sa ZHANG, Beijing (CN); Feifei SUN, Beijing (CN); Zhe CHEN, Beijing (CN)

(21) Appl. No.: 19/469,757

(22) PCT Filed: Mar. 26, 2024
(86) PCT No.: PCT/KR2024/003782

§ 371 Date: Sep. 26, 2025

(30) Foreign Application Priority Data
Mar. 29, 2023 (CN) 202310325494.X

(51) Int. Cl. H04W 52/14; H04L 5/00; H04W 72/21

(52) U.S. Cl. CPC H04W 52/146; H04L 5/0055; H04W 72/21

(57) ABSTRACT

The disclosure relates to a 5G or 6G communication system for supporting a higher data transmission rate. A method and an apparatus for transmission of an uplink signal in a wireless communication system are provided. The method includes receiving first information, where the first information is used for configuring or indicating a terminal to transmit uplink control information (UCI) in a physical uplink control channel (PUCCH), determining a transmission power of the PUCCH based on the first information, and transmitting the PUCCH based on the determined transmission power, where in case that the UCI includes two or more UCI bit sequences, the transmission power of the PUCCH is determined based on at least one of the two or more UCI bit sequences. The invention provides an enhanced communication method and apparatus.

### TECHNICAL FIELD

The disclosure relates to the field of wireless communication, and more particularly, to a method and an apparatus for transmission of an uplink signal in a wireless communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service-based architecture or service-based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Solution to Problem

According to at least one embodiment of the disclosure, a method performed by a terminal in a wireless communication system is provided. The method includes: receiving first information, where the first information is used for configuring or indicating a terminal to transmit uplink control information (UCI) in a physical uplink control channel (PUCCH); determining a transmission power of the PUCCH based on the first information; and transmitting the PUCCH based on the determined transmission power, where in case that the UCI includes two or more UCI bit sequences, the transmission power of the PUCCH is determined based on at least one of the two or more UCI bit sequences.

In combination with one or more aspects of the method performed by the terminal described above, in some implementations, for example, in case that the UCI includes two or more UCI bit sequences, the transmission power of the PUCCH is determined based on one UCI bit sequence of the two or more UCI bit sequences.

In combination with one or more aspects of the method performed by the terminal described above, in some implementations, for example, the one UCI bit sequence of the two or more UCI bit sequences is a combination of one or more of: a hybrid automatic repeat request-acknowledgement (HARQ-ACK) bit sequence; a scheduling request (SR)) bit sequence; or a bit sequence of a Part 1 channel state information (CSI) report.

In combination with one or more aspects of the method performed by the terminal described above, in some implementations, for example, in case that the two or more UCI bit sequences include a first UCI bit sequence and a second UCI bit sequence, where the first UCI bit sequence includes a Part 1 CSI report and the second UCI bit sequence includes a Part 2 CSI report, the first UCI bit sequence is determined as the one UCI bit sequence.

In combination with one or more aspects of the method performed by the terminal described above, in some implementations, for example, the first UCI bit sequence further includes at least one of HARQ-ACK or an SR.

In combination with one or more aspects of the method performed by the terminal described above, in some implementations, for example, the one UCI bit sequence of the two or more UCI bit sequences is a UCI bit sequence with a highest priority of the two or more UCI bit sequences.

In combination with one or more aspects of the method performed by the terminal described above, in some implementations, for example, in case that the two or more UCI bit sequences include a third UCI bit sequence and a fourth UCI bit sequence, where the third UCI bit sequence includes a UCI of a first priority and the fourth UCI bit sequence includes a UCI of a second priority, and the first priority is higher than the second priority, then the third UCI bit sequence is determined as the one UCI bit sequence.

In combination with one or more aspects of the method performed by the terminal described above, in some implementations, for example, determining the transmission power of the PUCCH based on one UCI bit sequence of the two or more UCI bit sequences includes: determining a first parameter related to transmission power adjustment of the PUCCH based on the one UCI bit sequence; and determining the transmission power of the PUCCH based on the determined first parameter.

In combination with one or more aspects of the method performed by the terminal described above, in some implementations, for example, the first parameter is further determined based on a second parameter, where the second parameter indicates a minimum value of a number of UCI bits for power control.

In combination with one or more aspects of the method performed by the terminal described above, in some implementations, for example, the first parameter is further determined based on a second parameter, where the second parameter is configured for UCI multiplexing with different priorities and indicates a minimum value of a number of UCI bits for power control.

In combination with one or more aspects of the method performed by the terminal described above, in some implementations, for example, the first parameter is further determined based on a number of bits of a HARQ-ACK codebook when a third parameter is configured, where the third parameter indicates that the number of bits of the HARQ-ACK codebook is used to determine the first parameter.

In combination with one or more aspects of the method performed by the terminal described above, in some implementations, for example, in case that the UCI includes the two or more UCI bit sequences, the transmission power of the PUCCH is determined based on a UCI bit sequence with a smallest UCI bit sequence index of the two or more UCI bit sequences.

In combination with one or more aspects of the method performed by the terminal described above, in some implementations, for example, in case that the UCI includes the two or more UCI bit sequences, the transmission power of the PUCCH is determined based on a UCI bit sequence with a largest UCI bit sequence index of the two or more UCI bit sequences.

In combination with one or more aspects of the method performed by the terminal described above, in some implementations, for example, the one UCI bit sequence of the two or more UCI bit sequences is configured by higher layer signaling and/or indicated by downlink control information (DCI).

In combination with one or more aspects of the method performed by the terminal described above, in some implementations, for example, in case that the UCI includes the two or more UCI bit sequences, the transmission power of the PUCCH is determined based on all of the two or more UCI bit sequences.

In combination with one or more aspects of the method performed by the terminal described above, in some implementations, for example, determining the transmission power of the PUCCH based on all of the two or more UCI bit sequences includes: determining first parameters related to transmission power adjustment of the PUCCH based on each of the two or more UCI bit sequences; and determining the transmission power of the PUCCH based on a first parameter with a maximum value of the determined first parameters, or determining the transmission power of the PUCCH based on a first parameter with a minimum value of the determined first parameters.

In combination with one or more aspects of the method performed by the terminal described above, in some implementations, for example, determining the transmission power of the PUCCH based on all of the two or more UCI bit sequences includes: determining first parameters related to transmission power adjustment of the PUCCH based on each of the two or more UCI bit sequences; and determining the transmission power of the PUCCH based on a first parameter with a minimum value of the determined first parameters.

In combination with one or more aspects of the method performed by the terminal described above, in some implementations, for example, the first parameter is determined based on at least one of the UCI bit sequences or a second parameter, where the second parameter indicates a minimum value of a number of UCI bits for power control.

In combination with one or more aspects of the method performed by the terminal described above, in some implementations, for example, determining the transmission power of the PUCCH based on all of the two or more UCI bit sequences includes: determining first transmission powers of the PUCCH based on each of the two or more UCI bit sequences; and determining a first transmission power with a maximum value of the determined first transmission powers as the transmission power of the PUCCH.

In combination with one or more aspects of the method performed by the terminal described above, in some implementations, for example, determining the transmission power of the PUCCH based on all of the two or more UCI bit sequences includes: determining a first transmission power of the PUCCH based on each of the two or more UCI bit sequences; and determining a first transmission power with a minimum value of the determined first transmission power as the transmission power of the PUCCH.

In combination with one or more aspects of the method performed by the terminal described above, in some implementations, for example, the two or more UCI bit sequences are encoded separately.

According to at least one embodiment of the disclosure, a method performed by a base station in a wireless communication system is provided. The method includes: transmitting first information, where the first information is used for configuring or indicating a terminal to transmit uplink control information (UCI) in a physical uplink control channel (PUCCH); and receiving the PUCCH transmitted by the terminal, where in case that the UCI includes two or more UCI bit sequences, a transmission power of the PUCCH by the terminal is determined based on at least one of the two or more UCI bit sequences.

In combination with one or more aspects of the method performed by the base station described above, in some implementations, for example, the method further includes transmitting second information to the terminal, where in case that the UCI includes the two or more UCI bit sequences, the second information indicates that one UCI bit sequence of the two or more UCI bit sequences is used to determine the transmission power of the PUCCH.

In combination with one or more aspects of the method performed by the base station described above, in some implementations, for example, the method further includes transmitting third information to the terminal, where the third information indicates that a number of bits of a Hybrid Automatic Repeat Request-Acknowledgement (HARQ-ACK) codebook is used to determine a first parameter related to transmission power adjustment of the PUCCH.

In combination with one or more aspects of the method performed by the base station described above, in some implementations, for example, the two or more UCI bit sequences are encoded separately.

According to at least one embodiment of the disclosure, a terminal in a wireless communication system is further provided. The terminal includes: a transceiver; and a controller, coupled with the transceiver and configured to perform one or more aspects of the method performed by the terminal described above.

According to at least one embodiment of the disclosure, a base station in a wireless communication system is further provided. The base station includes: a transceiver; and a controller, coupled with the transceiver and configured to perform one or more aspects of the method performed by the base station described above.

According to at least one embodiment of the disclosure, a computer-readable storage medium on which one or more computer programs are stored is further provided, where one or more aspects of the method described above can be implemented when the one or more computer programs are executed by one or more processors.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure, in which:

FIG. 1 illustrates a schematic diagram of an example wireless network according to some embodiments of the disclosure;

FIG. 2A illustrates example wireless transmission and reception paths according to some embodiments of the disclosure;

FIG. 2B illustrates example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 illustrates a block diagram of a first transceiving node according to some embodiments of the disclosure;

FIG. 5 illustrates a block diagram of a second transceiving node according to some embodiments of the disclosure;

FIG. 6 illustrates a flowchart of a method performed by a base station according to some embodiments of the disclosure;

FIG. 7 illustrates a flowchart of a method performed by a UE according to some embodiments of the disclosure;

FIG. 8A illustrates an example of uplink transmission timing according to some embodiments of the disclosure;

FIG. 8B illustrates an example of uplink transmission timing according to some embodiments of the disclosure;

FIG. 8C illustrates an example of uplink transmission timing according to some embodiments of the disclosure;

FIG. 9A illustrates an example of time domain resource allocation table according to some embodiments of the disclosure;

FIG. 9B illustrates an example of time domain resource allocation table according to some embodiments of the disclosure;

FIG. 10 illustrates a flowchart of a method performed by a terminal according to some embodiments of the disclosure; and

FIG. 11 illustrates a flowchart of a method performed by a base station according to some embodiments of the disclosure.

### MODE FOR THE INVENTION

In order to make the purpose, technical schemes and advantages of the embodiments of the disclosure clearer, the technical schemes of the embodiments of the disclosure will be described clearly and completely with reference to the drawings of the embodiments of the disclosure. Apparently, the described embodiments are a part of the embodiments of the disclosure, but not all embodiments. Based on the described embodiments of the disclosure, all other embodiments obtained by those of ordinary skill in the art without creative labor belong to the protection scope of the disclosure.

Before undertaking the DETAILED DESCRIPTION below, it can be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely. The phrase “at least one of,” when used with a list of items, means that different combinations of one or more of the listed items can be used, and only one item in the list can be needed. For example, “at least one of: A, B, and C” includes any of the following combinations: A, B, C, A and B, A and C, B and C, and A and B and C. For example, “at least one of: A, B, or C” includes any of the following combinations: A, B, C, A and B, A and C, B and C, and A, B and C.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

Terms used herein to describe the embodiments of the disclosure are not intended to limit and/or define the scope of the present invention. For example, unless otherwise defined, the technical terms or scientific terms used in the disclosure shall have the ordinary meaning understood by those with ordinary skills in the art to which the present invention belongs.

It should be understood that “first”, “second” and similar words used in the disclosure do not express any order, quantity or importance, but are only used to distinguish different components. Similar words such as singular forms “a”, “an” or “the” do not express a limitation of quantity, but express the existence of at least one of the referenced item, unless the context clearly dictates otherwise. For example, reference to “a component surface” includes reference to one or more of such surfaces.

As used herein, any reference to “an example” or “example”, “an implementation” or “implementation”, “an embodiment” or “embodiment” means that particular elements, features, structures or characteristics described in connection with the embodiment is included in at least one embodiment. The phrases “in one embodiment” or “in one example” appearing in different places in the specification do not necessarily refer to the same embodiment.

As used herein, “a portion of” something means “at least some of” the thing, and as such may mean less than all of, or all of, the thing. As such, “a portion of” a thing includes the entire thing as a special case, i.e., the entire thing is an example of a portion of the thing.

As used herein, the term “set” means one or more. Accordingly, a set of items can be a single item or a collection of two or more items.

In this disclosure, to determine whether a specific condition is satisfied or fulfilled, expressions, such as “greater than/larger than” or “less than/smaller than” are used by way of example and expressions, such as “greater than or equal to” or “less than or equal to” are also applicable and not excluded. For example, a condition defined with “greater than or equal to” may be replaced by “greater than” (or vice-versa), a condition defined with “less than or equal to” may be replaced by “less than” (or vice-versa), etc.

It will be further understood that similar words such as the term “include” or “comprise” mean that elements or objects appearing before the word encompass the listed elements or objects appearing after the word and their equivalents, but other elements or objects are not excluded. Similar words such as “connect” or “connected” are not limited to physical or mechanical connection, but can include electrical connection, whether direct or indirect. “Upper”, “lower”, “left” and “right” are only used to express a relative positional relationship, and when an absolute position of the described object changes, the relative positional relationship may change accordingly.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-LTE systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G communication systems, those skilled in the art will understand that the main points of the disclosure can also be applied to other communication systems with similar technical backgrounds and channel formats with slight modifications without departing from the scope of the disclosure. The technical schemes of the embodiments of the present application can be applied to various communication systems, and for example, the communication systems may include global systems for mobile communications (GSM), code division multiple access (CDMA) systems, wideband code division multiple access (WCDMA) systems, general packet radio service (GPRS) systems, long term evolution (LTE) systems, LTE frequency division duplex (FDD) systems, LTE time division duplex (TDD) systems, universal mobile telecommunications system (UMTS), worldwide interoperability for microwave access (WiMAX) communication systems, 5th generation (5G) systems or new radio (NR) systems, etc. In addition, the technical schemes of the embodiments of the present application can be applied to future-oriented communication technologies.

Hereinafter, the embodiments of the disclosure will be described in detail with reference to the accompanying drawings. It should be noted that the same reference numerals in different drawings will be used to refer to the same elements already described.

The text and drawings are provided as examples only to help readers understand the disclosure. They are not intended and should not be interpreted as limiting the scope of the disclosure in any way. Although certain embodiments and examples have been provided, based on the content disclosed herein, it will be apparent to those skilled in the art that changes may be made to the illustrated embodiments and examples without departing from the scope of the disclosure.

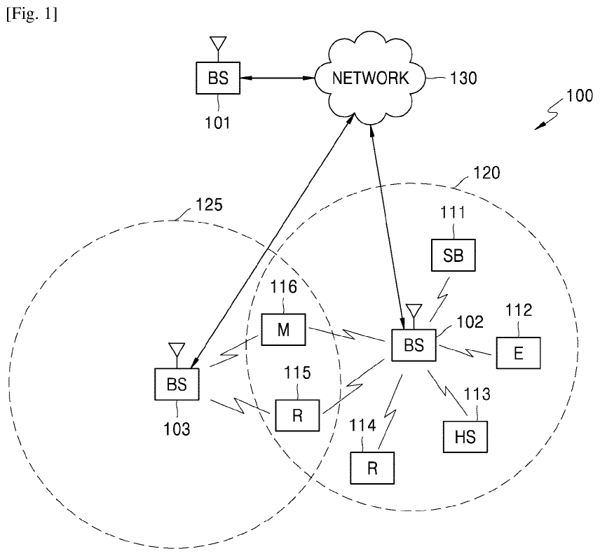

The following FIGS. 1-3B describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to some embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station (BS)” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For example, the terms “terminal”, “user equipment” and “UE” may be used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

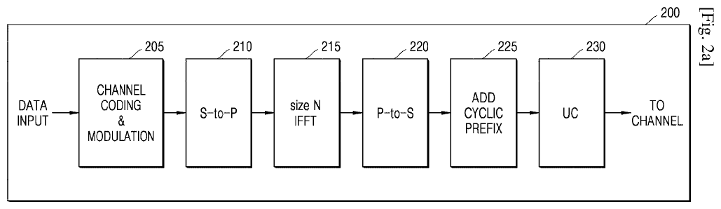

FIGS. 2A and 2B illustrate example wireless transmission and reception paths according to some embodiments of the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time domain output signal. The Parallel-to-Serial block 220 converts (such as multiplexes) parallel time domain output symbols from the Size N IFFT block 215 to generate a serial time domain signal. The cyclic prefix addition block 225 inserts a cyclic prefix into the time domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time domain baseband signal. The Serial-to-Parallel block 265 converts the time domain baseband signal into a parallel time domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

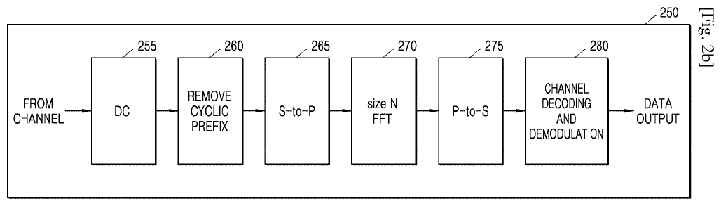

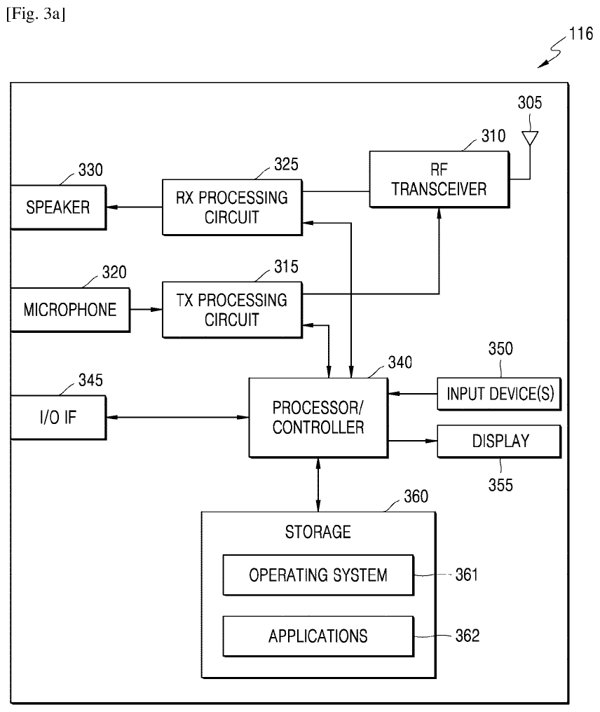

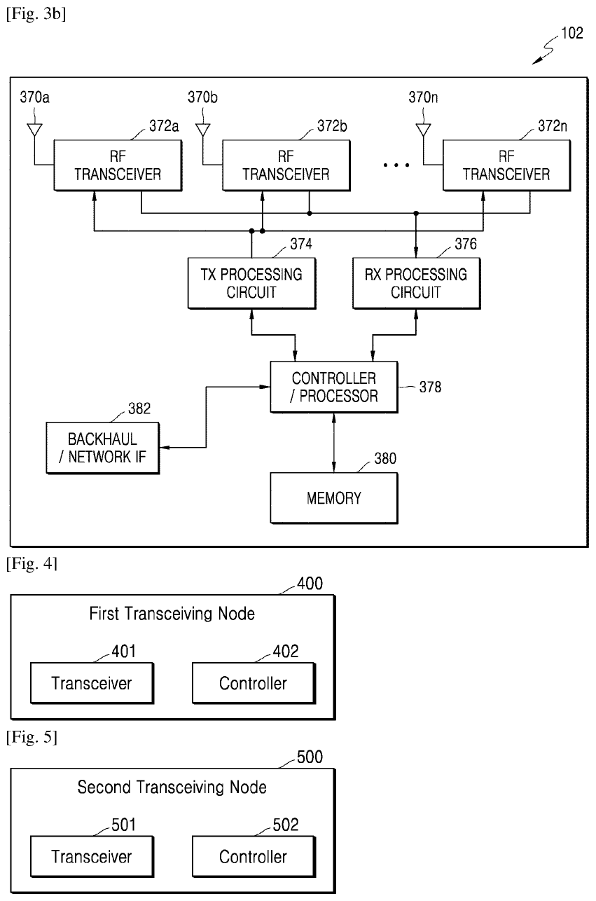

FIG. 3A illustrates an example UE 116 according to some embodiments of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

In some implementations, two or more UEs 116 may communicate directly using one or more sidelink channels (for example, without using a base station as a medium for communication with each other). For example, the UE 116 may communicate using peer-to-peer (P2P) communication, device-to-device (D2D) communication, vehicle-to-everything (V2X) protocol (which, for example, may include vehicle-to-vehicle (V2V) protocol, vehicle-to-infrastructure (V2I) protocol, etc.), mesh network, etc. In this case, the UE 116 may perform scheduling operations, resource selection operations, and/or other operations performed by the base station as described elsewhere herein. For example, the base station may configure the UE 116 via downlink control information (DCI), radio resource control (RRC) signaling, medium access control-control element (MAC-CE) or via system information (e.g., system information block (SIB)).

FIG. 3B illustrates an example gNB 102 according to some embodiments of the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include a RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Those skilled in the art will understand that, “terminal” and “terminal device” as used herein include not only devices with wireless signal receiver which have no transmitting capability, but also devices with receiving and transmitting hardware which can carry out bidirectional communication on a bidirectional communication link. Such devices may include cellular or other communication devices with single-line displays or multi-line displays or cellular or other communication devices without multi-line displays; a PCS (personal communications service), which may combine voice, data processing, fax and/or data communication capabilities; a PDA (Personal Digital Assistant), which may include a radio frequency receiver, a pager, an internet/intranet access, a web browser, a notepad, a calendar and/or a GPS (Global Positioning System) receiver; a conventional laptop and/or palmtop computer or other devices having and/or including a radio frequency receiver. “Terminal” and “terminal device” as used herein may be portable, transportable, installed in vehicles (aviation, sea transportation and/or land), or suitable and/or configured to operate locally, and/or in distributed form, operate on the earth and/or any other position in space. “Terminal” and “terminal device” as used herein may also be a communication terminal, an internet terminal, a music/video playing terminal, such as a PDA, a MID (Mobile Internet Device) and/or a mobile phone with music/video playing functions, a smart TV, a settop box and other devices.

With the rapid development of information industry, especially the increasing demand from mobile Internet and internet of things (IoT), it brings unprecedented challenges to the future mobile communication technology. In order to meet the unprecedented challenges, the communication industry and academia have carried out extensive research on the fifth generation (5G) mobile communication technology to face the 2020s. At present in ITU report ITU-R M.[IMT.VISION], the framework and overall goals of the future 5G has been discussed, in which the demand outlook, application scenarios and important performance indicators of 5G are described in detail. With respect to new requirements in 5G, ITU report ITU-R M.[IMT.FUTURE TECHNOLOGY TRENDS] provides information related to the technology trends of 5G, aiming at solving significant problems such as significantly improved system throughput, consistent user experience, scalability to support IoT, delay, energy efficiency, cost, network flexibility, support of emerging services and flexible spectrum utilization. In 3GPP (3rd Generation Partnership Project), the first stage of 5G is already in progress. To support more flexible scheduling, the 3GPP decides to support variable hybrid automatic repeat request-acknowledgement (HARQ-ACK) feedback delay in 5G. In existing Long Term Evolution (LTE) systems, a time from reception of downlink data to uplink transmission of HARQ-ACK is fixed. For example, in Frequency Division Duplex (FDD) systems, the delay is 4 subframes. In Time Division Duplex (TDD) systems, a HARQ-ACK feedback delay is determined for a corresponding downlink subframe based on an uplink and downlink configuration. In 5G systems, whether FDD or TDD systems, for a determined downlink time unit (for example, a downlink slot or a downlink mini slot; for another example, a PDSCH time unit), the uplink time unit (for example, a PUCCH time unit) that can feedback HARQ-ACK is variable. For example, the delay of HARQ-ACK feedback can be dynamically indicated by physical layer signaling, or different HARQ-ACK delays can be determined based on factors such as different services or user capabilities.

The 3GPP has defined three directions of 5G application scenarios-eMBB (enhanced mobile broadband), mMTC (massive machine-type communication) and URLLC (ultra-reliable and low-latency communication). The eMBB scenario aims to further improve data transmission rate on the basis of the existing mobile broadband service scenario, so as to enhance user experience and pursue ultimate communication experience between people. mMTC and URLLC are, for example, the application scenarios of the Internet of Things, but their respective emphases are different: mMTC being mainly information interaction between people and things, while URLLC mainly reflecting communication requirements between things.

In some cases, different types of UCIs or UCIs of a same type and different priorities have different reliability requirements, so that the different types of UCIs or the UCIs of the same type and the different priorities can be coded/encoded by separate coding/encoding. How to reduce power consumption of the UE under the premise of ensuring transmission reliability of the UCI is a problem to be resolved. Therefore, an enhanced uplink signal transmission method for the UE is needed.

In order to at least resolve the above technical problems, embodiments of the disclosure provide a method performed by a terminal, the terminal, a method performed by a base station, and the base station in a wireless communication system, and a non-transitory computer-readable storage medium. Hereinafter, various embodiments of the disclosure will be described in detail with reference to the accompanying drawings.

In this disclosure, a transceiving node can refer a node transmitting or receiving data with another node in a communication system. In embodiments of the disclosure, for the convenience of description, a first transceiving node and a second transceiving node are defined. For example, the first transceiving node may be a base station, and the second transceiving node may be a UE. For another example, the embodiments of the disclosure may be applicable to the scenario of sidelink communication, in which case, the first transceiving node may be a UE, and the second transceiving node may be another UE. Therefore, the first transceiving node and the second transceiving node may each be any suitable communication node. In the following description, the base station is taken as an example (but not limited thereto) to illustrate the first transceiving node, and the UE is taken as an example (but not limited thereto) to illustrate the second transceiving node.

In describing a wireless communication system and in the disclosure described below, higher layer signaling or higher layer signals may be signal transferring methods for transferring information from a base station to a terminal over a downlink data channel of a physical layer or from a terminal to a base station over an uplink data channel of a physical layer, and examples of the signal transferring methods may include signal transferring methods for transferring information via Radio Resource Control (RRC) signaling, Packet Data Convergence Protocol (PDCP) signaling, or a Medium Access Control (MAC) Control Element (CE).

In the following description of the disclosure, higher layer signaling may be signaling corresponding to at least one or a combination of one or more of the following signaling.
MIB (master information block)
SIB (system information block) or SIB X (X=1, 2, . . . )
RRC signaling
MAC CE

Physical layer (Layer 1 (L1)) signaling may be signaling corresponding to at least one or a combination of one or more of the following signaling.
PDCCH (physical downlink control channel)
DCI (downlink control information)
UE-specific DCI
group common DCI
common DCI
scheduling DCI (for example, DCI for scheduling downlink or uplink data)
non-scheduling DCI (for example, DCI other than DCI for scheduling downlink or uplink data)
PUCCH (physical uplink control channel)
UCI (uplink control information)

In embodiments of the disclosure, uplink control signaling may include physical layer signaling and/or higher layer signaling. As described above, the physical layer signaling may include UCI and/or PUCCH, and the higher layer signaling may include RRC signaling and/or a MAC CE.

In embodiments of the disclosure, downlink control signaling may include physical layer signaling and/or higher layer signaling. As mentioned above, the physical layer signaling may include one or more of PDCCH, DCI, UE-specific DCI, group common DCI, common DCI, scheduling DCI (for example, DCI for scheduling downlink or uplink data), and non-scheduling DCI, and the higher layer signaling may include one or more of a MIB, a SIB or SIB X (X=1, 2, . . . ), RRC signaling or a MAC CE. Therefore, “configuring or indicating X through downlink control signaling” will be understood as configuring or indicating X through physical layer signaling, or configuring or indicating X through higher layer signaling, or configuring or indicating X through a combination of higher layer signaling and physical layer signaling.

FIG. 4 illustrates a block diagram of a first transceiving node 400 according to some embodiments of the disclosure.

Referring to FIG. 4, the first transceiving node 400 may include a transceiver 401 and a controller 402.

The transceiver 401 may be configured to transmit first data and/or first control signaling to a second transceiving node, and/or receive second data and/or second control signaling from the second transceiving node in a time unit.

The controller 402 may be an application specific integrated circuit or at least one processor. The controller 402 may be configured to control the overall operation of the first transceiving node 400, including controlling the transceiver 401 to transmit the first data and/or the first control signaling to the second transceiving node and receive the second data and/or the second control signaling from the second transceiving node in the time unit.

In some implementations, the controller 402 may be configured to perform one or more of operations in methods of various embodiments described below, for example, operations that can be performed by a base station.

In the following description, the base station is taken as an example (but not limited thereto) to illustrate the first transceiving node, and the UE is taken as an example (but not limited thereto) to illustrate the second transceiving node. Downlink data (but not limited thereto) is used to illustrate the first data. Downlink control signaling (but not limited thereto) is used to illustrate the first control signaling. Uplink control signaling (but not limited thereto) is used to illustrate the second control signaling.

Herein, depending on the network type, the term “base station” or “BS” can refer to any component (or a set of components) configured to provide wireless access to a network, such as a Transmission Point (TP), a Transmission and Reception Point (TRP), an evolved base station (eNodeB or eNB), a 5G base station (gNB), a macrocell, a femtocell, a WiFi access point (AP), or other wirelessly enabled devices. Base stations may provide wireless access in accordance with one or more wireless communication protocols, e.g., 5G 3GPP new radio (NR) interface/access, Long Term Evolution (LTE), LTE advanced (LTE-A), High Speed Packet Access (HSPA), Wi-Fi 802.11a/b/g/n/ac, etc.

FIG. 5 illustrates a block diagram of a second transceiving node according to some embodiments of the disclosure.

Referring to FIG. 5, the second transceiving node 500 may include a transceiver 501 and a controller 502.

The transceiver 501 may be configured to receive first data and/or first control signaling from the first transceiving node, and transmit second data and/or second control signaling to the first transceiving node in a determined time unit.

The controller 502 may be an application specific integrated circuit or at least one processor. The controller 502 may be configured to control the overall operation of the second transceiving node and control the second transceiving node to implement the methods proposed in the embodiments of the disclosure. For example, the controller 502 may be configured to determine the second data and/or the second control signaling and a time unit for transmitting the second data and/or the second control signaling based on the first data and/or the first control signaling, and control the transceiver 501 to transmit the second data and/or the second control signaling to the first transceiving node in the determined time unit.

In some implementations, the controller 502 may be configured to perform one or more of operations in methods of various embodiments described below, for example, operations that can be performed by a terminal (UE).

In implementations described in connection with FIG. 4 or 5, the first data may be data transmitted by the first transceiving node to the second transceiving node. In the following examples, downlink data carried by a PDSCH (Physical Downlink Shared Channel) is taken as an example (but not limited thereto) to illustrate the first data.

In implementations described in connection with FIG. 4 or 5, the second data may be data transmitted by the second transceiving node to the first transceiving node. In the following examples, uplink data carried by a PUSCH (Physical Uplink Shared Channel) is taken as an example (but not limited thereto) to illustrate the second data.

In implementations described in connection with FIG. 4 or 5, the first control signaling may be control signaling transmitted by the first transceiving node to the second transceiving node. In the following examples, downlink control signaling is taken as an example (but not limited thereto) to illustrate the first control signaling. The downlink control signaling may be DCI (downlink control information) carried by a PDCCH (Physical Downlink Control Channel) and/or control signaling carried by a PDSCH (Physical Downlink Shared Channel). For example, the DCI may be UE specific DCI, and the DCI may also be common DCI. The common DCI may be DCI common to a part of UEs, such as group common DCI, and the common DCI may also be DCI common to all of the UEs. The DCI may be uplink DCI (e.g., DCI for scheduling a PUSCH) and/or downlink DCI (e.g., DCI for scheduling a PDSCH).

In implementations described in connection with FIG. 4 or 5, the second control signaling may be control signaling transmitted by the second transceiving node to the first transceiving node. In the following examples, uplink control signaling is taken as an example (but is not limited thereto) to illustrate the second control signaling. The uplink control signaling may be UCI (Uplink Control Information) carried by a PUCCH (Physical Uplink Control Channel) and/or control signaling carried by a PUSCH (Physical Uplink Shared Channel). A type of UCI may include one or more of: HARQ-ACK information, SR (Scheduling Request), LRR (Link Recovery Request), CSI (Chanel State Information), or CG (Configured Grant) UCI. In embodiments of the disclosure, when UCI is carried by a PUCCH, the UCI may be used interchangeably with the PUCCH.

In some implementations, a PUCCH with an SR may be a PUCCH with a positive SR and/or a negative SR. The SR may be the positive SR and/or the negative SR.

In some implementations, the CSI may include one or more of: CQI (Channel Quality Indicator), PMI (Precoding Matrix Indicator), CRI (CSI-RS Resource Indicator), SSB RI (SS/PBCH Block Resource Indicator), LI (Layer Indicator), RI (Rank Indicator), L1-RSRP (Layer 1 Reference Signal Received Power).

In some implementations, the CSI or CSI report may be wideband CSI and/or subband CSI.

In some implementations, the CSI or CSI report may also be Part 1 CSI and/or Part 2 CSI.

In implementations described in connection with FIG. 4 or 5, a first time unit is a time unit in which the first transceiving node transmits the first data and/or the first control signaling. In some examples, a downlink time unit or downlink slot may be taken as an example (but not limited thereto) to illustrate the first time unit.

In implementations described in connection with FIG. 4 or 5, a second time unit is a time unit in which the second transceiving node transmits the second data and/or the second control signaling. In the following examples, an uplink time unit or uplink slot or PUCCH slot or PCell (Primary Cell) slot or PUCCH slot on PCell is taken as an example (but not limited thereto) to illustrate the second time unit. The “PUCCH slot” may be understood as a PUCCH transmission slot.

In embodiments of the disclosure, a time unit (for example, the first time unit or the second time unit) may be one or more slots, one or more subslots, one or more OFDM symbols, one or more spans, or one or more subframes.

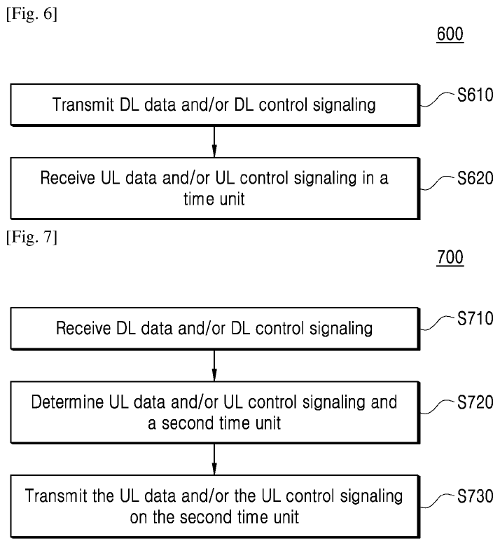

FIG. 6 illustrates a flowchart of a method 600 performed by a base station according to some embodiments of the disclosure.

Referring to FIG. 6, in operation S610, the base station transmits downlink data and/or downlink control signaling.

In operation S620, the base station receives uplink data and/or uplink control signaling from a UE in a time unit.

In some implementations, operations S610 and/or S620 may be performed based on the methods described according to various embodiments of the disclosure (e.g., various methods/manners described below).

In some implementations, the method 600 may omit one or more of operation S610 or S620, or may include additional operations, for example, the operations performed by the base station based on the methods described according to various embodiments of the disclosure (e.g., various methods/manners described below).

FIG. 7 illustrates a flowchart of a method 700 performed by a UE according to embodiments of the disclosure.

Referring to FIG. 7, in operation S710, the UE may receive downlink (DL) data (e.g., downlink data carried by a PDSCH) and/or downlink control signaling from a base station. For example, the UE may receive the downlink data and/or the downlink control signaling from the base station based on predefined rules and/or received configuration parameters.

In operation S720, the UE determines uplink (UL) data and/or uplink control signaling, a transmission power of the uplink data and/or uplink control signaling, and a second time unit based on the downlink data and/or the downlink control signaling.

In operation S730, the UE transmits the uplink data and/or the uplink control signaling to the base station in the second time unit based on the determined transmission power.

In some implementations, operations S710 and/or S720 and/or S730 may be performed based on the methods described according to various embodiments of the disclosure (e.g., various methods/manners described below).

In some implementations, the method 700 may omit one or more of operation S710, S720 or S730, or may include additional operations, for example, the operations performed by the UE (terminal) based on the methods described according to various embodiments of the disclosure (e.g., various methods/manners described below).

In some implementations, acknowledgement/negative acknowledgement (ACK/NACK) for downlink transmissions may be performed through HARQ-ACK.

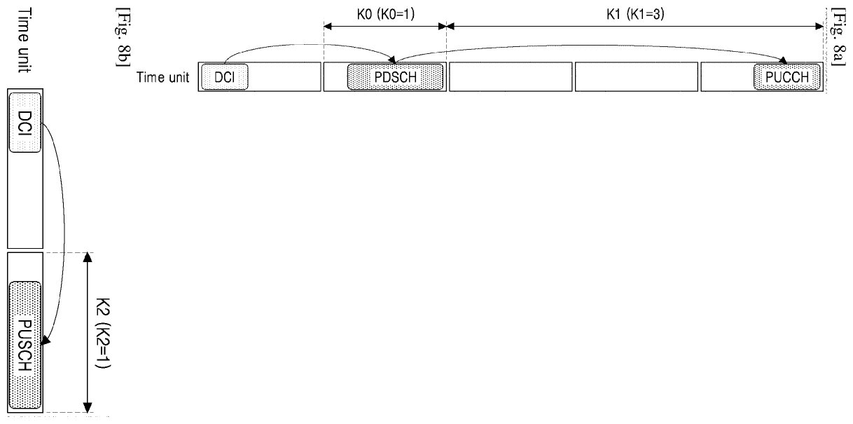

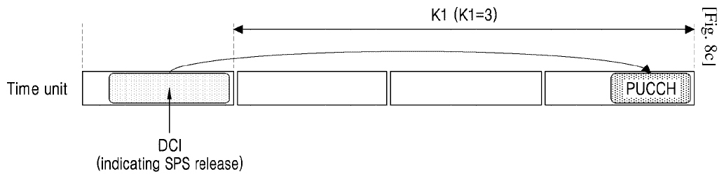

In some implementations, the downlink control signaling may include DCI carried by a PDCCH and/or control signaling carried by a PDSCH. For example, the DCI may be used to schedule transmission of a PUSCH or reception of a PDSCH. Some examples of uplink transmission timing will be described below with reference to FIGS. 8A-8C.

In an example, the UE receives the DCI and receives the PDSCH based on time domain resources indicated by the DCI. For example, a parameter K0 may be used to represent a time interval between the PDSCH scheduled by the DCI and the PDCCH carrying the DCI, and K0 may be in units of slots. For example, FIG. 8A gives an example in which K0=1. In the example illustrated in FIG. 8A, the time interval from the PDSCH scheduled by the DCI to the PDCCH carrying the DCI is one slot. In an embodiment of the disclosure, “a UE receives DCI” may mean that “the UE detects the DCI.”

In another example, the UE receives the DCI and transmits the PUSCH based on time domain resources indicated by the DCI. For example, a timing parameter K2 may be used to represent a time interval between the PUSCH scheduled by the DCI and the PDCCH carrying the DCI, and K2 may be in units of slots. For example, FIG. 8B gives an example in which K2=1. In the example illustrated in FIG. 8B, the time interval between the PUSCH scheduled by the DCI and the PDCCH carrying the DCI is one slot. K2 may also represent a time interval between a PDCCH for activating a CG (configured grant) PUSCH and the first activated CG PUSCH. In examples of the disclosure, unless otherwise specified, the PUSCH may be a dynamically scheduled PUSCH (e.g., scheduled by DCI) (e.g., may be referred to as DG (dynamic grant) PUSCH, in an embodiment of the disclosure) and/or a PUSCH not scheduled by DCI (e.g., CG PUSCH).

In yet another example, the UE receives the PDSCH, and may transmit HARQ-ACK information for the PDSCH reception in a PUCCH in the second time unit. For example, a timing parameter (which may also be referred to as a timing value) K1 (e.g., the higher layer parameter dl-DataToUL-ACK) may be used to represent a time interval between the PUCCH for transmitting the HARQ-ACK information for the PDSCH reception and the PDSCH, and K1 may be in units of second time units, such as slots or subslots. In a case where K1 is in units of slots, the time interval is a value of a slot offset between the PUCCH for feeding back the HARQ-ACK information for the PDSCH reception and the PDSCH, and K1 may be referred to as a slot timing value. For example, FIG. 8A gives an example in which K1=3. In the example illustrated in FIG. 8A, the time interval between the PUCCH for transmitting the HARQ-ACK information for the PDSCH reception and the PDSCH is 3 slots. It should be noted that in embodiments of the disclosure, the timing parameter K1 may be used interchangeably with a timing parameter K1, the timing parameter K0 may be used interchangeably with a timing parameter K0, and the timing parameter K2 may be used interchangeably with a timing parameter K2.

The PDSCH may be a PDSCH scheduled by the DCI and/or a SPS (Semi-Persistent Scheduling) PDSCH. The UE will periodically receive the SPS PDSCH after the SPS PDSCH is activated by the DCI. In examples of the disclosure, the SPS PDSCH may be equivalent to a PDSCH not scheduled by the DCI/PDCCH. After the SPS PDSCH is released (deactivated), the UE will no longer receive the SPS PDSCH.

In embodiments of the disclosure, HARQ-ACK may be HARQ-ACK for a SPS PDSCH reception (e.g., HARQ-ACK not indicated by DCI) and/or HARQ-ACK indicated by a DCI format (e.g., HARQ-ACK for a PDSCH reception scheduled by a DCI format).

In yet another example, the UE receives the DCI (e.g., DCI indicating SPS PDSCH release (deactivation)), and may transmit HARQ-ACK information for the DCI in the PUCCH in the second time unit. For example, the timing parameter K1 may be used to represent a time interval between the PUCCH for transmitting the HARQ-ACK information for the DCI and the DCI, and K1 may be in units of second time units, such as slots or subslots. For example, FIG. 8C gives an example in which K1=3. In the example of FIG. 8C, the time interval between the PUCCH for transmitting the HARQ-ACK information for the DCI and the DCI is 3 slots. For example, the timing parameter K1 may be used to represent a time interval between a PDCCH reception carrying DCI indicating SPS PDSCH release (deactivation) and the PUCCH feeding back HARQ-ACK for the PDCCH reception.

In some implementations, in step S520, the UE may report (or signal/transmit) a UE capability to the base station or indicate the UE capability. For example, the UE reports (or signals/transmits) the UE capability to the base station by transmitting the PUSCH. In this case, UE capability information is included in the PUSCH transmitted by the UE.

In some implementations, the base station may configure higher layer signaling for the UE based on the UE capability previously received from the UE (e.g., in step S510 in the previous downlink-uplink transmission processes). For example, the base station configures the higher layer signaling for the UE by transmitting the PDSCH. In this case, the higher layer signaling configured for the UE is included in the PDSCH transmitted by the base station. It should be noted that the higher layer signaling is higher layer signaling compared with physical layer signaling, and for example, the higher layer signaling may include RRC signaling and/or a MAC CE.

In some implementations, downlink channels (downlink resources) may include PDCCHs and/or PDSCHs. Uplink channels (uplink resources) may include PUCCHs and/or PUSCHs.

In some implementations, the UE may be configured with two levels of priorities for uplink transmission (for example, the UE is configured with the higher layer parameter PUCCH-ConfigurationList). For example, the UE may be configured to multiplex UCIs with different priorities via higher layer signaling (e.g., via higher layer parameter uci-Mux WithDiffPrio), otherwise (e.g., if the UE is not configured to multiplex UCIs with different priorities), the UE performs prioritization for PUCCHs and/or PUSCHs with different priorities. For example, the two levels of priorities may include a first priority and a second priority which are different from each other. In an example, the first priority may be higher than the second priority, that is, the first priority is the higher priority, and the second priority is the lower priority. In another example, the first priority may be lower than the second priority. However, embodiments of the disclosure are not limited to this, and for example, the UE may be configured with more than two levels of priorities. For the sake of convenience, in embodiments of the disclosure, description will be made considering that the first priority is higher than the second priority. It should be noted that all embodiments of the disclosure are applicable to situations where the first priority may be higher than the second priority; all embodiments of the disclosure are applicable to situations where the first priority may be lower than the second priority; and all embodiments of the disclosure are applicable to situations where the first priority may be equal to the second priority. In some embodiments of the disclosure, the terms “first priority”, “higher priority”, “greater priority index” and “priority index 1” may be used interchangeably. In embodiments of the disclosure, the terms “second priority”, “lower priority”, “smaller priority index” and “priority index 0” may be used interchangeably.

For example, multiplexing of multiple PUCCHs and/or PUSCHs overlapping in time domain may include multiplexing of UCI of the PUCCH in a PUCCH or PUSCH.

For example, prioritizing of two PUCCHs and/or PUSCHs overlapping in time domain by the UE may include that the UE transmits the PUCCH or the PUSCH with the higher priority and/or the UE does not transmit the PUCCH or the PUSCH with the lower priority.

In some implementations, the UE may be configured with a subslot-based PUCCH transmission. For example, a subslot length parameter (which may also be referred to as a parameter with respect to a subslot length in embodiments of the disclosure) (e.g., the higher layer parameter subslotLengthForPUCCH) of each PUCCH configuration parameter of the first PUCCH configuration parameter and the second PUCCH configuration parameter may be 7 OFDM symbols or 6 OFDM symbols or 2 OFDM symbols. Subslot configuration length parameters in different PUCCH configuration parameters may be configured separately. If no subslot length parameter is configured in a PUCCH configuration parameter, the scheduling time unit of the PUCCH configuration parameter is one slot by default. If a subslot length parameter is configured in the PUCCH configuration parameter, the scheduling time unit of the PUCCH configuration parameter is L (L is the configured subslot configuration length) OFDM symbols.

The mechanism of a slot-based PUCCH transmission is basically the same as that of a subslot-based PUCCH transmission. In the disclosure, a slot may be used to represent a PUCCH occasion unit; for example, if the UE is configured with subslots, a slot which is a PUCCH occasion unit may be replaced with a subslot. For example, it may be specified by protocols that if the UE is configured with the subslot length parameter (e.g., the higher layer parameter subslotLengthForPUCCH), unless otherwise indicated, a number of symbols included in the slot of the PUCCH transmission is indicated by the subslot length parameter.

For example, if the UE is configured with the subslot length parameter, and a subslot n is the last uplink subslot overlapping with a PDSCH reception or PDCCH reception (e.g., SPS PDSCH release, and/or indicating SCell dormancy, and/or triggering a Type-3 HARQ-ACK codebook report and without scheduling a PDSCH reception), then HARQ-ACK information for the PDSCH reception or PDCCH reception is transmitted in an uplink subslot n+k, where k is determined by the timing parameter K1 (the definition of the timing parameter K1 may refer to the previous description). For another example, if the UE is not configured with the subslot length parameter, and a slot n is the last uplink slot overlapping with a downlink slot where the PDSCH reception or PDCCH reception is located, then the HARQ-ACK information for the PDSCH reception or PDCCH reception is transmitted in an uplink slot n+k, where K is determined by the timing parameter K1.

In embodiments of the disclosure, unicast may refer to a manner in which a network communicates with a UE, and multicast (or groupcast) may refer to a manner in which a network communicates with multiple UEs. For example, a unicast PDSCH may be a PDSCH received by one UE, and scrambling of the PDSCH may be based on a Radio Network Temporary Identifier (RNTI) specific to the UE, e.g., Cell-RNTI (C-RNTI). A multicast PDSCH may be a PDSCH received by more than one UE simultaneously, and scrambling of the multicast PDSCH may be based on a UE-group common RNTI. For example, the UE-group common RNTI for scrambling the multicast PDSCH may include an RNTI (which may be referred to as Group RNTI (G-RNTI) in embodiments of the disclosure) for scrambling of a dynamically scheduled multicast transmission (e.g., PDSCH) or an RNTI (which may be referred to as group configured scheduling RNTI (G-CS-RNTI) in embodiments of the disclosure) for scrambling of a multicast SPS transmission (e.g., SPS PDSCH). UCI of the unicast PDSCH may include HARQ-ACK information, an SR, or CSI of the unicast PDSCH reception. UCI of the multicast PDSCH may include HARQ-ACK information of the multicast PDSCH reception. In embodiments of the disclosure, “multicast” may also be replaced by “broadcast”.

In some implementations, a HARQ-ACK codebook may include HARQ-ACK information for one or more PDSCHs and/or DCI. If the HARQ-ACK information for the one or more PDSCHs and/or DCI is transmitted in a same second time unit, the UE may generate the HARQ-ACK codebook based on a predefined rule. For example, if a PDSCH is successfully decoded, the HARQ-ACK information for the PDSCH reception is positive ACK. The positive ACK may be represented by 1 in the HARQ-ACK codebook, for example. If a PDSCH is not successfully decoded, the HARQ-ACK information for the PDSCH reception is Negative ACK (NACK). The NACK may be represented by 0 in the HARQ-ACK codebook, for example. For example, the UE may generate the HARQ-ACK codebook based on pseudo code specified by protocols. In an example, if the UE receives a DCI format that indicates SPS PDSCH release (deactivation), the UE transmits HARQ-ACK information (ACK) for the DCI format. In another example, if the UE receives a DCI format that indicates secondary cell dormancy, the UE transmits HARQ-ACK information (ACK) for the DCI format. In yet another example, if the UE receives a DCI format that indicates to transmit HARQ-ACK information (e.g., a Type-3 HARQ-ACK codebook) of all HARQ-ACK processes of all configured serving cells, the UE transmits the HARQ-ACK information of all the HARQ-ACK processes of all the configured serving cells. In order to reduce a size of the Type-3 HARQ-ACK codebook, in an enhanced Type-3 HARQ-ACK codebook, the UE may transmit HARQ-ACK information of a specific HARQ-ACK process of a specific serving cell based on an indication of the DCI. In yet another example, if the UE receives a DCI format that schedules a PDSCH, the UE transmits HARQ-ACK information for the PDSCH reception. In yet another example, the UE receives a SPS PDSCH, and the UE transmits HARQ-ACK information for the SPS PDSCH reception. In yet another example, if the UE is configured by higher layer signaling to receive a SPS PDSCH, the UE transmits HARQ-ACK information for the SPS PDSCH reception. The reception of the SPS PDSCH configured by higher layer signaling may be cancelled by other signaling. In yet another example, if at least one uplink symbol (e.g., OFDM symbol) of the UE in a semi-static frame structure configured by higher layer signaling overlaps with a symbol of the SPS PDSCH reception, the UE does not receive the SPS PDSCH. In yet another example, if the UE is configured by higher layer signaling to receive a SPS PDSCH according to a predefined rule, the UE transmits HARQ-ACK information for the SPS PDSCH reception. It should be noted that, in embodiments of the disclosure, “‘A’ overlaps with ‘B’” may mean that ‘A’ at least partially overlaps with ‘B’. That is, “‘A’ overlaps with ‘B’” includes a case where ‘A’ completely overlaps with ‘B’. “‘A’ overlaps with ‘B“ ” may mean that ‘A’ overlaps with ‘B’ in time domain and/or ‘A’ overlaps with ‘B’ in frequency domain.

In some implementations, if HARQ-ACK information transmitted in a same second time unit does not include HARQ-ACK information for any DCI format, nor does it include HARQ-ACK information for a dynamically scheduled PDSCH (e.g., a PDSCH scheduled by a DCI format) and/or DCI, or the HARQ-ACK information transmitted in the same second time unit only includes HARQ-ACK information for one or more SPS PDSCHs receptions, the UE may generate HARQ-ACK information (e.g., HARQ-ACK information only for SPS PDSCH receptions) according to a rule for generating a HARQ-ACK codebook for SPS PDSCHs. The UE may multiplex the HARQ-ACK information only for SPS PDSCH receptions in a specific PUCCH resource. For example, if the UE is configured with a PUCCH list parameter for SPS (e.g., SPS-PUCCH-AN-List), the UE multiplexes the HARQ-ACK information only for SPS PDSCH receptions in a PUCCH of a PUCCH list for SPS. For example, the UE determines a PUCCH resource in the PUCCH list for the SPS according to a number of HARQ-ACK information bits. If the UE is not configured with the PUCCH list parameter for SPS, the UE multiplexes the HARQ-ACK information only for SPS PDSCH receptions in a PUCCH resource specific to SPS HARQ-ACK (for example, the PUCCH resource is configured by the parameter n1PUCCH-AN).

In some implementations, if the HARQ-ACK information transmitted in the same second time unit includes HARQ-ACK information for a DCI format, and/or a dynamically scheduled PDSCH (e.g., a PDSCH scheduled by a DCI format), the UE may generate HARQ-ACK information according to a rule for generating a HARQ-ACK codebook for a dynamically scheduled PDSCH and/or a DCI format. For example, the UE may determine to generate a semi-static HARQ-ACK codebook (e.g., Type-1 HARQ-ACK codebook) or a dynamic HARQ-ACK codebook (e.g., Type-2 HARQ-ACK codebook) according to a PDSCH HARQ-ACK codebook configuration parameter (e.g., the higher layer parameter pdsch-HARQ-ACK-Codebook). The dynamic HARQ-ACK codebook may also be an enhanced dynamic HARQ-ACK codebook (e.g., Type-2 HARQ-ACK codebook based on grouping and HARQ-ACK retransmission). The UE may multiplex the HARQ-ACK information in a PUCCH resource for HARQ-ACK associated with dynamically scheduling, which may be configured in a resource set list parameter (e.g., the parameter resourceSetToAddModList). The UE determines a PUCCH resource set (e.g., the parameter PUCCHResourceSet) in a resource set list according to a number of HARQ-ACK information bits, and the PUCCH resource may be determined as a PUCCH in the PUCCH resource set according to a PRI (PUCCH Resource Indicator) field indication in the last DCI format.

In some implementations, if the HARQ-ACK information transmitted in the same second time unit includes only HARQ-ACK information for SPS PDSCHs (e.g., a PDSCH not scheduled by a DCI format), the UE may generate the HARQ-ACK codebook according to a rule for generating a HARQ-ACK codebook for SPS PDSCH receptions (e.g., the pseudo code of a HARQ-ACK codebook for SPS PDSCH receptions).

The semi-static HARQ-ACK codebook (e.g., Type-1 HARQ-ACK codebook), may determine the size of the HARQ-ACK codebook and an order of HARQ-ACK information bits according to a semi-statically configured parameter (e.g., a parameter configured by higher layer signaling).

For a serving cell c, an active downlink BWP (bandwidth part), and an active uplink BWP, the UE determines a set of M_{A,c} occasions for candidate PDSCH receptions for which the UE can transmit corresponding HARQ-ACK information in a PUCCH in an uplink slot n_{U}.

M_{A,c} may be determined by at least one of:
a) a set of HARQ-ACK slot timing values K1 associated with the active uplink BWP on a primary cell or PUCCH-sScell (PUCCH switching SCell);
b) a set of row indexes of a time domain resource allocation (TDRA) table associated with the downlink active BWP;
c) 2^{μ}^{_{DL}}^{·μ}^{_{UL}}, where μ_{DL} is the configuration of a downlink subcarrier spacing (SCS) of the downlink active BWP, and μ_{UL} is the configuration of an uplink subcarrier spacing of the uplink active BWP.
d) a semi-static uplink and downlink frame structure configuration, such as the parameter tdd-UL-DL-ConfigurationCommon and the parameter tdd-UL-DL-ConfigurationDedicated.
e) a downlink slot offset parameter (e.g., the higher layer parameter

$${N}_{slot , offset , c}^{DL} )$$

for the serving cell c and its corresponding slot offset SCS (e.g., the higher layer parameter μ_{offest,DL,c}), and a slot offset parameter (e.g., the higher layer parameter

$${N}_{slot , offset}^{UL} )$$

for a primary cell and its corresponding slot offset SCS (e.g., the higher layer parameter μ_{offset,UL}).

The set of the parameter K1 is used to determine a candidate uplink slot, and then determine candidate downlink slots according to the candidate uplink slot. The candidate downlink slots satisfy at least one of the following conditions: (i) if the time unit of the PUCCH is a subslot, the end of at least one candidate PDSCH reception in the candidate downlink slots overlaps with the candidate uplink slot in time domain; or (ii) if the time unit of the PUCCH is a slot, the end of the candidate downlink slots overlaps with the candidate uplink slot in time domain. It should be noted that, in embodiments of the disclosure, a starting symbol may be used interchangeably with a starting position, and an end symbol may be used interchangeably with an end position. In some implementations, the starting symbol may be replaced by the end symbol, and/or the end symbol may be replaced by the starting symbol.

A number of PDSCHs in a candidate downlink slot for which HARQ-ACK needs to be fed back is determined by a maximum value of a number of non-overlapping valid PDSCHs in the downlink slot (e.g., the valid PDSCHs may be PDSCHs that do not overlap with semi-statically configured uplink symbols). Time domain resources occupied by the PDSCHs may be determined by (i) a time domain resource allocation table configured by higher layer signaling (in embodiments of the disclosure, it may also be referred to as a table associated with time domain resource allocation) and (ii) a certain row in the time domain resource allocation table dynamically indicated by a DCI. Each row in the time domain resource allocation table may define information with respect to time domain resource allocation. For example, for the time domain resource allocation table, an indexed row defines a timing value (e.g., time unit (e.g., slot) offset (e.g., K0)) between a PDCCH and a PDSCH, and a start and length indicator (SLIV), or directly defines a starting symbol and allocation length. For example, for the first row of the time domain resource allocation table, a starting OFDM symbol is 0 and an OFDM symbol length is 4; for the second row of the time domain resource allocation table, the starting OFDM symbol is 4 and the OFDM symbol length is 4; and for the third row of the time domain resource allocation table, the starting OFDM symbol is 7 and the OFDM symbol length is 4. The DCI for scheduling the PDSCH may indicate any row in the time domain resource allocation table. When all OFDM symbols in the downlink slot are downlink symbols, the maximum value of the number of non-overlapping valid PDSCHs in the downlink slot is 2. At this time, the Type-1 HARQ-ACK codebook may need to feed back HARQ-ACK information for two PDSCHs in the downlink slot on the serving cell.

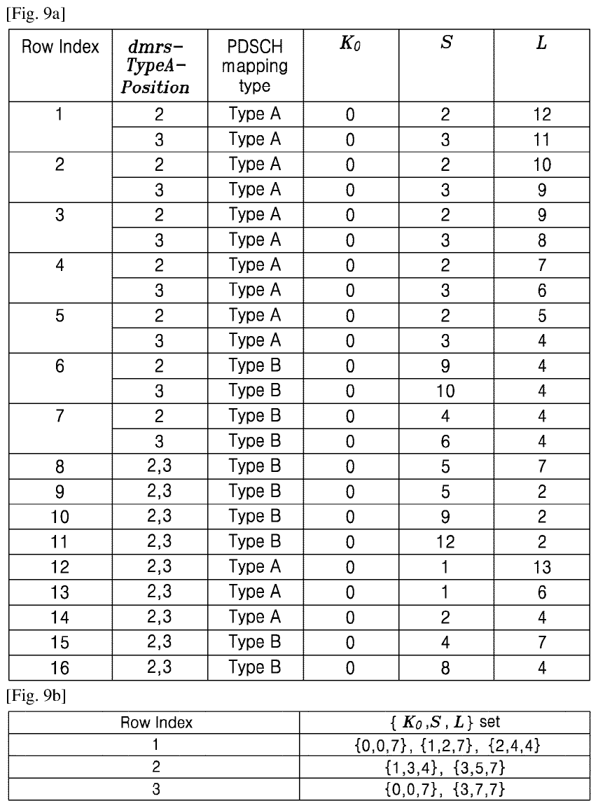

FIGS. 9A and 9B illustrate examples of time domain resource allocation tables. Specifically, FIG. 9A illustrates a time domain resource allocation table in which one PDSCH is scheduled in one row, and FIG. 9B illustrates a time domain resource allocation table in which multiple PDSCHs are scheduled in one row. Referring to FIG. 9A, each row corresponds to a set of {K0, mapping type, SLIV}, which includes a timing parameter K0 value, a mapping type, and an SLIV. Referring to FIG. 9B, unlike FIG. 9A, each row corresponds to multiple sets of {K0, mapping type, SLIV}.

In some implementations, the dynamic HARQ-ACK codebook (e.g., Type-2 HARQ-ACK codebook) and/or the enhanced dynamic HARQ-ACK codebook (e.g., Type-2 HARQ-ACK based on grouping and HARQ-ACK retransmission) may determine a size and an order of the HARQ-ACK codebook according to an assignment indicator. For example, the assignment indicator may be a DAI (Downlink Assignment Indicator). In the following embodiments, the assignment indicator as the DAI is taken as an example for illustration. However, the embodiments of the disclosure are not limited thereto, and any other suitable assignment indicator may be adopted.

In some implementations, a DAI field includes at least one of a first DAI and a second DAI.

In some examples, the first DAI may be a C-DAI (Counter-DAI). The first DAI may indicate an accumulative number of at least one of DCI scheduling PDSCH(s), DCI indicating SPS PDSCH release (deactivation), or DCI indicating secondary cell dormancy. For example, the accumulative number may be an accumulative number up to the current serving cell and/or the current time unit. For example, the C-DAI may refer to: an accumulative number of {serving cell, time unit} pair(s) scheduled by PDCCH(s) up to the current time unit within a time window (which may also include a number of PDCCHs (e.g., PDCCHs indicating SPS release and/or PDCCHs indicating secondary cell dormancy)); or an accumulative number of PDCCH(s) up to the current time unit; or an accumulative number of PDSCH transmission(s) up to the current time unit; or an accumulative number of {serving cell, time unit} pair(s) in which PDSCH transmission(s) related to PDCCH(s) (e.g., scheduled by the PDCCH(s)) and/or PDCCH(s) (e.g., PDCCH indicating SPS release and/or PDCCH indicating secondary cell dormancy) is present, up to the current serving cell and/or the current time unit; or an accumulative number of PDSCH(s) with corresponding PDCCH(s) and/or PDCCHs (e.g., PDCCHs indicating SPS release and/or PDCCHs indicating secondary cell dormancy) already scheduled by a base station up to the current serving cell and/or the current time unit; or an accumulative number of PDSCHs (the PDSCHs are PDSCHs with corresponding PDCCHs) already scheduled by the base station up to the current serving cell and/or the current time unit; or an accumulative number of time units with PDSCH transmissions (the PDSCHs are PDSCHs with corresponding PDCCHs) already scheduled by the base station up to the current serving cell and/or the current time unit. The order of each bit in the HARQ-ACK codebook corresponding to at least one of PDSCH reception(s), DCI(s) indicating SPS PDSCH release (deactivation), or DCI(s) indicating secondary cell dormancy may be determined by the time when the first DAI is received and the information of the first DAI. The first DAI may be included in a downlink DCI format.

In some examples, the second DAI may be a T-DAI (Total-DAI). The second DAI may indicate a total number of at least one of all PDSCH receptions, DCI indicating SPS PDSCH release (deactivation), or DCI indicating secondary cell dormancy. For example, the total number may be a total number of all serving cells up to the current time unit. For example, the T-DAI may refer to: a total number of {serving cell, time unit} pairs scheduled by PDCCH(s) up to the current time unit within a time window (which may also include a number of PDCCHs for indicating SPS release); or a total number of PDSCH transmissions up to the current time unit; or a total number of {serving cell, time unit} pairs in which PDSCH transmission(s) related to PDCCH(s) (e.g., scheduled by the PDCCH) and/or PDCCH(s) (e.g., a PDCCH indicating SPS release and/or a PDCCH indicating secondary cell dormancy) is present, up to the current serving cell and/or the current time unit; or a total number of PDSCHs with corresponding PDCCHs and/or PDCCHs (e.g., PDCCHs indicating SPS release and/or PDCCHs indicating secondary cell dormancy) already scheduled by a base station up to the current serving cell and/or the current time unit; or a total number of PDSCHs (the PDSCHs are PDSCHs with corresponding PDCCHs) already scheduled by the base station up to the current serving cell and/or the current time unit; or a total number of time units with PDSCH transmissions (e.g., the PDSCHs are PDSCHs with corresponding PDCCHs) already scheduled by the base station up to the current serving cell and/or the current time unit. The second DAI may be included in the downlink DCI format and/or an uplink DCI format. The second DAI included in the uplink DCI format is also referred to as an UL DAI.

In the following examples, the first DAI as the C-DAI and the second DAI as the T-DAI are taken as an example (but not limited thereto) for illustration.

Tables 1 and 2 show a correspondence between the DAI field and V_{T-DAI,m} or V_{C-DAI,c,m} or

$${V}_{T - DA 1}^{UL} .$$

For example, in case that a C-DAI or T-DAI in a DCI is represented with 2 bits, the value of the C-DAI or T-DAI in the DCI may be determined by equations in Table 1. V_{T-DAI,m} or

$${V}_{T - DA 1}^{UL}$$

is the value of the T-DAI in the DCI received in a PDCCH Monitoring Occasion (MO) m, and V_{C-DAI,c,m} is the value of the C-DAI in the DCI for a serving cell c received in the PDCCH monitoring occasion m. Both V_{T-DAI,m} and V_{C-DAI,c,m} are related to a number of bits of the DAI field in the DCI. MSB is the Most Significant Bit and LSB is the Least Significant Bit.

TABLE 1

| MSB, LSB of DAI Field | ${V}_{T - DAI , m} or {V}_{C - DAI , c , m} or {V}_{T - DAI}^{UL}$ | Y |
|---|---|---|
| 0, 0 | 1 | (Y − 1)mod4 + 1 = 1 |
| 0, 1 | 2 | (Y − 1)mod4 + 1 = 2 |
| 1, 0 | 3 | (Y − 1)mod4 + 1 = 3 |
| 1, 1 | 4 | (Y − 1)mod4 + 1 = 4 |

For example, when the C-DAI or T-DAI is 1, 5 or 9, as shown in Table 1, all of the DAI field are indicated with “00”, and the value of V_{T-DAI,m} and V_{C-DAI,c,m} is represented as “1” by the equation in Table 1. Y may represent the value of the DAI corresponding to the number of DCIs actually transmitted by the base station (the value of the DAI before conversion by the equation in the table).

For example, in case that the C-DAI or T-DAI in the DCI is 1 bit, values greater than 2 may be represented by equations in Table 2.

TABLE 2

| | V_{T-DAI, m} or | |
|---|---|---|
| DAI Field | V_{C-DAI, c, m} | Y |
| 0 | 1 | (Y-1)mod2 + 1 = 1 |
| 1 | 2 | (Y-1)mod2 + 1 = 2 |

In some implementations, whether to feed back HARQ-ACK information may be configured by higher layer parameters or dynamically indicated by a DCI. The mode of feeding back (or reporting) the HARQ-ACK information (HARQ-ACK feedback mode or HARQ-ACK reporting mode) may also be at least one of the following modes.

HARQ-ACK feedback mode 1: transmitting ACK or NACK (ACK/NACK). For example, for a PDSCH reception, if the UE decodes a corresponding transport block (TB) correctly, the UE transmits ACK; and/or, if the UE does not decode the corresponding transport block correctly, the UE transmits NACK. For example, a HARQ-ACK information bit of the HARQ-ACK information provided according to the HARQ-ACK feedback mode 1 is an ACK value or a NACK value.

HARQ-ACK feedback mode 2: transmitting NACK only (NACK-only). For example, for a PDSCH reception, if the UE decodes the corresponding transport block correctly, the UE does not transmit the HARQ-ACK information; and/or, if the UE does not decode the corresponding transport block correctly, the UE transmits NACK. For example, at least one HARQ-ACK information bit of the HARQ-ACK information provided according to the HARQ-ACK feedback mode 2 is a NACK value. For example, for the HARQ-ACK feedback mode 2, the UE does not transmit a PUCCH that would include only HARQ-ACK information with ACK values.

In some implementations, a PUSCH conflicting/colliding with other physical channel(s) may be at least one of:
the PUSCH overlapping in time domain with other PUSCH(s) and/or PUCCH(s) and/or PDSCH(s) and/or PDCCH(s) on a same serving cell; or
the PUSCH overlapping in time domain with a PUCCH. For example, the PUSCH overlaps in time domain with a PUCCH on a different serving cell, and/or the serving cell does not support simultaneous transmission of the PUSCH and the PUCCH.

In some implementations, a PDSCH conflicting/colliding with other physical channel(s) may be at least one of:
the PDSCH overlapping in time domain with other PUSCH(s) and/or PUCCH(s) and/or PDSCH(s) on a same serving cell; or
the PDSCH overlapping in both time domain and frequency domain with a PDCCH on a same serving cell.

In some implementations, a PUCCH conflicting/colliding with other physical channel(s) may be at least one of:
the PUCCH overlapping in time domain with other PUCCH(s) and/or PUSCH(s); or
the PUCCH overlapping in time domain with other PDSCH(s) on a same serving cell.

In some implementations, a PDCCH conflicting/colliding with other physical channel(s) may be at least one of:
the PDCCH overlapping in time domain with other PUSCH(s) and/or PUCCH(s) on a same serving cell; or
the PDCCH overlapping in both time domain and frequency domain with other PDSCH(s) on a same serving cell.

In some implementations, “a set of overlapping channels” may be understood as that each channel of the set of overlapping channels overlaps (or collides) with at least one of channels in the set except this channel. The channels may include one or more PUCCHs and/or one or more PUSCHs. For example, “a set of overlapping channels” may include “a set of overlapping PUCCHs and/or PUSCHs”. As a specific example, when a first PUCCH overlaps with at least one of a second PUCCH and a third PUCCH, the second PUCCH overlaps with at least one of the first PUCCH and the third PUCCH, and the third PUCCH overlaps with at least one of the first PUCCH and the second PUCCH, the first PUCCH, the second PUCCH and the third PUCCH constitute a set of overlapping channels (PUCCHs). For example, the first PUCCH overlaps with the second PUCCH and the third PUCCH, and the second PUCCH and the third PUCCH do not overlap.

It should be noted that, in embodiments of the disclosure, “resolving overlapping channels” may be understood as resolving the collision of overlapping channels. For example, when a PUCCH overlaps with a PUSCH, resolving the overlapping or collision may include multiplexing UCI of the PUCCH in the PUSCH, or may include transmitting the PUCCH or PUSCH with a higher priority. For another example, when a PUCCH overlaps with one or another PUCCH, resolving the overlapping or collision may include multiplexing UCI in a PUCCH, or may include transmitting the PUCCH with a higher priority. For yet another example, when two PUSCHs on a same serving cell overlap, resolving the overlapping or collision may include transmitting a PUSCH with a higher priority of the two PUSCHs.

It should be noted that, unless the context clearly indicates otherwise, all or one or more of the methods, steps or operations described in embodiments of the disclosure may be specified by protocols and/or configured by higher layer signaling and/or indicated by dynamic signaling. The dynamic signaling may be a PDCCH and/or DCI and/or a DCI format. For example, a SPS PDSCH and/or CG PUSCH may be dynamically indicated in a corresponding activated DCI/DCI format/PDCCH. All or one or more of the described methods, steps and operations may be optional. For example, if a certain parameter (e.g., parameter X) is configured, the UE performs a certain approach (e.g., approach A), otherwise (if the parameter, e.g., parameter X, is not configured), the UE performs another approach (e.g., approach B). Unless otherwise specified, the parameters in the embodiments of the disclosure may be higher layer parameters. For example, the higher layer parameters may be parameters configured or indicated by higher layer signaling (e.g., RRC signaling).

It should be noted that, a PCell (Primary Cell) or PSCell (Primary Secondary Cell) in embodiments of the disclosure may be used interchangeably with a cell having a PUCCH. A serving cell may be used interchangeably with a cell.

It should be noted that, methods for downlink in embodiments of the disclosure may also be applicable to uplink, and methods for uplink may also be applicable to downlink. For example, a PDSCH may be replaced with a PUSCH, a SPS PDSCH may be replaced with a CG PUSCH, and downlink symbols may be replaced with uplink symbols, so that methods for downlink may be applicable to uplink.

It should be noted that, methods applicable to scheduling multiple PDSCHs/PUSCHs in embodiments of the disclosure may also be applicable to a PDSCH/PUSCH transmission with repetitions. For example, a PDSCH/PUSCH of multiple PDSCHs/PUSCHs may be replaced by a repetition of multiple repetitions of the PDSCH/PUSCH transmission.

It should be noted that in methods of the disclosure, “configured with and/or indicated a transmission with repetitions” may be understood that a number of the repetitions of the transmission is greater than 1. For example, “configured with and/or indicated a PUCCH transmission with repetitions” may be understood that “the PUCCH transmission is repeated on more than one slot/subslot”. “Not configured with and/or indicated a transmission with repetitions” may be understood that a number of the repetitions of the transmission is equal to 1. For example, “not configured with and/or indicated a PUCCH transmission with repetitions” may be understood that “a number of the repetitions of the PUCCH transmission is equal to 1”. For example, the UE may be configured with a parameter

$${N}_{PUCCH}^{repeat}$$

related to a number of repetitions of a PUCCH transmission; when the parameter

$${N}_{PUCCH}^{repeat}$$

is greater than 1, it may mean that the UE is configured with a PUCCH transmission with repetitions, and the UE may repeat the PUCCH transmission on

$${N}_{PUCCH}^{repeat}$$

time units (e.g., slots); when the parameter is equal to 1, it may mean that the UE is not configured with a PUCCH transmission with repetitions. For example, the PUCCH transmission with repetitions may include only one type of UCI. If the PUCCH is configured with repetitions, in embodiments of the disclosure, a repetition of the multiple repetitions of the PUCCH may be used as a PUCCH (or a PUCCH resource), or all of the repetitions of the PUCCH may be used as a PUCCH (or a PUCCH resource), or a specific repetition of the multiple repetitions of the PUCCH may be used as a PUCCH (or a PUCCH resource).

It should be noted that, in methods of the disclosure, a PDCCH and/or DCI and/or a DCI format schedules multiple PDSCHs/PUSCHs, which may be multiple PDSCHs/PUSCHs on a same serving cell and/or multiple PDSCHs/PUSCHs on different serving cells.

It should be noted that, multiple manners/methods described in the disclosure may be combined in any order. In a combination, a manner may be performed one or more times.

It should be noted that, steps/operations of manners/methods of the disclosure may be implemented in any order.

It should be noted that, in embodiments of the disclosure, “canceling a transmission” may mean canceling the transmission of the entire uplink channel and/or cancelling the transmission of a part of the uplink channel.

It should be noted that, in embodiments of the disclosure, “an order from small to large” (e.g., an ascending order) may be replaced by “an order from large to small” (e.g., a descending order), and/or “an order from large to small” (e.g., a descending order) may be replaced by “an order from small to large” (e.g., an ascending order).

It should be noted that, in embodiments of the disclosure, a PUCCH/PUSCH carrying/with A may be understood as a PUCCH/PUSCH only carrying/with A, and may also be understood as a PUCCH/PUSCH carrying/with at least A.

It should be noted that, in embodiments of the disclosure, “slot” may be replaced by “subslot” or “time unit”.

It should be noted that, in embodiments of the disclosure, “performing a predefined method (or step) if a predefined condition is satisfied” and “not performing the predefined method (or step) if the predefined condition is not satisfied” may be used interchangeably. “Not performing a predefined method (or step) if a predefined condition is satisfied” and “performing the predefined method (or step) if the predefined condition is not satisfied” may be used interchangeably.

In some implementations, the UE may be configured by higher layer signaling or indicated by dynamic signaling to transmit UCI. UCI may be carried by a PUCCH. If multiple PUCCHs overlap in time domain, the UE may multiplex UCI carried in multiple PUCCHs in one PUCCH. In some cases, different types of UCI or UCIs of a same type with different priorities have different reliability requirements, so that a manner of separate coding/encoding (or independent coding/encoding) may be adopted. Coding/encoding may be understood as channel coding/encoding. For example, a Part 1 CSI report and a Part 2 CSI report may be encoded separately. For another example, HARQ-ACK with a higher priority and HARQ-ACK with a lower priority may be encoded separately. In some other cases, the reliability requirements of different types of UCIs are proximate (or similar), and joint coding/encoding (or unified coding/encoding) may be adopted. For another example, HARQ-ACK, an SR and a Part 1 CSI report may be jointly encoded. The HARQ-ACK, the SR and the Part 1 CSI report are encoded separately from the part 2 CSI report.

In some embodiments of the disclosure, when multiple UCIs are encoded separately, each of the multiple UCIs is encoded separately. On the contrary, when multiple UCIs are jointly encoded, the multiple UCIs are encoded as a whole. In embodiments of the disclosure, two UCIs or two UCI groups (or UCI sets) are taken as an example to explain the methods of encoding separately, and these methods are also applicable to scenarios with more than two UCIs or more than two UCI groups. When separate encoding is used, each UCI corresponds to a UCI bit sequence (in embodiments of the disclosure, it may also be simply referred to as “bit sequence”), or each UCI group corresponds to a bit sequence. As an example, when two UCIs are a Part 1 CSI report and a Part 2 CSI report, respectively, two bit sequences are generated, where information bits of the Part 1 CSI report are (or are mapped to) a first bit sequence, and information bits of the Part 2 CSI report are (or are mapped to) a second bit sequence. As another example, if at least one of CSI reports in a PUCCH transmission includes two parts (or is of two parts), two bit sequences are generated. As another example, when the first UCI group includes HARQ-ACK and a Part 1 CSI report, and the second UCI group includes a Part 2 CSI report, two bit sequences are generated, where information bits of the HARQ-ACK and the Part 1 CSI report are (or are mapped to) the first bit sequence, and information bits of the Part 2 CSI report are (or are mapped to) the second bit sequence. As another example, if the UE is configured with a parameter related to UCI multiplexing with different priorities (e.g., the higher layer parameter uci-Mux WithDiffPrio), and is to transmit HARQ-ACK information bits of the lower priority, HARQ-ACK information bits of the higher priority, and SR information bits of the higher priority (if any) in the PUCCH, two UCI bit sequences are generated, where the HARQ-ACK information bits of the higher priority and the SR information bits of the higher priority (if any) are (or are mapped to) the first bit sequence, and the HARQ-ACK information bits of the lower priority are (or are mapped to) the second bit sequence. The case of generating two or more UCI bit sequences described above is only an example, and the embodiments of the disclosure are not limited thereto. For example, the embodiments of the disclosure may be applied to any case of generating two or more UCI bit sequences. In addition, a type of each of the two or more UCI bit sequences may be various UCI types, as described in various embodiments of the disclosure.

When a UCI in a PUCCH includes two UCIs or two UCI groups that are encoded separately, how to determine a transmission power of the PUCCH is a problem to be resolved.

In some implementations, at least one of Methods MN1 to MN11 may be used to determine the transmission power of the PUCCH.

### Method MN1

In Method MN1, the UE may be configured by higher layer signaling or indicated by dynamic signaling to transmit the UCI in a PUCCH. For example, the UE may receive first information (e.g., from a base station), where the first information may include higher layer signaling configured to transmit the UCI in the PUCCH and/or dynamic signaling indicating to transmit the UCI in the PUCCH. The first information may also include configuration information related to the transmission power of the PUCCH.

In Method MN1, the UE may determine the transmission power of the PUCCH based on the first information. For example, if the UCI in the PUCCH includes two or more bit sequences, the UE may determine the transmission power of the PUCCH based on at least one of the two or more bit sequences.

In Method MN1, the UE may transmit the PUCCH. For example, the UE may transmit the PUCCH based on the determined transmission power.

It should be noted that the above condition “the UCI in the PUCCH includes two or more bit sequences” may be replaced by at least one of the following conditions:
First condition: the UCI (or a CSI report) in the PUCCH includes a Part 2 CSI report.
Second condition: the UCI (or the CSI report) in the PUCCH includes (or is of) two parts.
Third condition: the UCI (or the CSI report) in the PUCCH includes subband CSI.
Fourth condition: the UCI in the PUCCH includes UCIs of different priorities. For example, the fourth condition may be that the UCI in the PUCCH includes UCIs of different physical layer priorities.
Fifth condition: the UCI in the PUCCH of the higher priority includes HARQ-ACK of the lower priority.
Sixth condition: the UCI in the PUCCH includes HARQ-ACK of the higher priority and/or HARQ-ACK of the lower priority.

The method provides a method for determining the PUCCH power by the UE under the condition that the UCI includes multiple bit sequences. This may ensure the accuracy of determining the PUCCH power and improve the reliability of the UCI transmission and reduce the interference to other UEs.

### Method MN2

According to some aspects of Method MN2, “determine the transmission power of the PUCCH based on at least one of the two or more bit sequences” in Method MN1 may include determining a PUCCH transmission power adjustment component (in embodiments of the disclosure, it may be referred to as a first parameter) based on at least one of the two or more bit sequences. For example, the first parameter may be a PUCCH transmission power adjustment component Δ_{TF,b,f,c}(i) on an active uplink BWP b of a carrier f in a primary cell c. Here, i is a transmission occasion of PUCCH. The transmission power of the PUCCH may be determined based on the first parameter. For example, the transmission power of the PUCCH may be determined based on Δ_{TF,b,f,c}(i).

In an example, if the UE transmits the PUCCH on the active uplink BWP b of the carrier f in the primary cell c using the PUCCH power control adjustment state with an index 1, the UE may determine the transmission power P_{PUCCH,b,f,c}(i,qᵤ,q_{d},l) of the PUCCH in the PUCCH transmission occasion i based on the following equation 1.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot \\ {M}_{RB , b , f , c}^{PUCCH} ( i ) ) + {PL}_{b , f , c} ( {q}_{d} ) + \\ {Δ}_{F \_ PUCCH} ( F ) + {Δ}_{TF , b , f , c} ( i ) + \\ {g}_{b , f , c} ( i , l )\end{matrix}\end{matrix} \} \qquad [ Equation 1 ]$$

where:
P_{CMAX,f,c}(i) is the UE configured maximum output power for the carrier f of the primary cell c in the PUCCH transmission occasion i.
P_{O_PUCCH,b,f,c}(qᵤ) is the sum of PUCCH power control parameters P0 (for example, a sum of a component P_{O_NOMINAL,PUCCH} (0 if not provided) provided by the higher layer parameter p0-nominal and a component P_{O_UE_PUCCH} (if provided) provided by the higher layer parameter p0-PUCCH-Value).
μ is a subcarrier spacing of the active uplink BWP b of the carrier f in the primary cell c.

$${M}_{RB , b , f , c}^{PUCCH} ( i )$$

is a transmission bandwidth of the PUCCH expressed in number of resource blocks (RBs) for the PUCCH transmission occasion i on the active uplink BWP b of the carrier f of the primary cell c.
PL_{b,f,c}(q_{d}) is a downlink path loss measurement for a reference signal (e.g., reference signal resource) with an index q_{d} for the active uplink BWP b of the carrier f of the primary cell c.
Δ_{F_PUCCH}(F) is a correction value related to a PUCCH format (for example, which may be referred to as a deltaF-PUCCH parameter), and its value depends on the PUCCH format. For example, Δ_{F_PUCCH}(F) is a value of deltaF-PUCCH-f0 for PUCCH format 0, deltaF-PUCCH-f1 for PUCCH format 1, deltaF-PUCCH-f2 for PUCCH format 2, deltaF-PUCCH-f3 for PUCCH format 3, deltaF-PUCCH-f4 for PUCCH format 4, if provided; otherwise, Δ_{F_PUCCH}(F) is equal to 0.

Δ_{TF,b,f,c}(i) is a PUCCH transmission power adjustment component on the active uplink BWP b of the carrier f of the primary cell c for the PUCCH transmission occasion i.
g_{b,f,c}(i,l) is the PUCCH power control adjustment state for the active uplink BWP b of the carrier f of the primary cell c and the PUCCH transmission occasion i.

### Method MN3

According to some aspects of Method MN3, the UE determining the transmission power of the PUCCH based on the first information or the UE determining the first parameter based on the first information in Method MN1 and/or Method MN2 may include the UE determining the transmission power of the PUCCH or determining the first parameter based on one bit sequence (in embodiments of the disclosure, the bit sequence may be referred to as a reference bit sequence for convenience of description) of the two or more bit sequences and/or a related parameter of the reference bit sequence. In an example of Method MN3, when the UCI includes the two or more bit sequences (e.g., two or more bit sequences that are encoded separately), the first parameter or the transmission power of the PUCCH may be determined by considering only one bit sequence (reference bit sequence) of the two or more bit sequences (e.g., without considering other bit sequences in the two or more bit sequences).

For example, the reference bit sequence may be determined by at least one of Methods MN4 to MN6.

The method is simple to implement, can reduce the implementation complexity of the UE and the base station, and can ensure the reliability of the UCI transmission corresponding to the reference bit sequence.

### Method MN4

According to some aspects of Method MN4, the reference bit sequence in Method MN3 may be a bit sequence including at least one of the following UCI:

### HARQ-ACK

### SR

### Part 1 CSI Report

That is, for a bit sequence of the two or more bit sequences included in the UCI, if the bit sequence includes at least one of HARQ-ACK, SR or Part 1 CSI report, the UE may determine that the bit sequence is the reference bit sequence. The UE may determine the transmission power of the PUCCH based on the reference bit sequence or determine the first parameter, that is, the PUCCH transmission power adjustment component based on the reference bit sequence.

In an example, the UCI in the PUCCH includes two bit sequences, where the first bit sequence includes a Part 1 CSI report and the second bit sequence includes a Part 2 CSI report. Additionally or alternatively, the first bit sequence also includes HARQ-ACK and/or an SR. The UE may determine the transmission power of the PUCCH or determine the first parameter based on the first bit sequence (the Part 1 CSI report and/or the HARQ-ACK and/or the SR) and/or a related parameter of the first bit sequence (the Part 1 CSI report and/or the HARQ-ACK and/or the SR).

For example, the first parameter Δ_{TF,b,f,c}(i) (for example, Δ_{TF,b,f,c}(i) in Equation 1 in Method MN2) may be determined as follows. Here, a first UCI may include at least one of HARQ-ACK, an SR or a Part 1 CSI report. For example, the first UCI may correspond to the first bit sequence.

For a PUCCH transmission using PUCCH format 2 or PUCCH format 3 or PUCCH format 4 and for a number of bits of the first UCI smaller than or equal to a predetermined number (for example, 11), the UE may determine the first parameter Δ_{TF,b,f,c}(i) based on the following Equation 2.

$$[ Equation 2 ]$$

$${Δ}_{TF , b , f , c} ( i ) = 10 {log}_{10} ( {K}_{1} \cdot ( {n}_{H A R Q - A C K} ( i ) + {O}_{S R} ( i ) + {O}_{C S I} ( i ) ) / {N}_{R E} ( i ) )$$

where:
K1 is a constant, for example, K1=6.
n_{HARQ-ACK}(i) is a number of HARQ-ACK information bits for power control (for example, for determining or obtaining the transmission power of the PUCCH) in case that the number of bits of the first UCI is smaller than or equal to the predetermined number (for example, 11). For example, for a semi-static HARQ-ACK codebook, the number of HARQ-ACK information bits for power control is a number of received TB or CBG (code block group). n_{HARQ-ACK}(i) is 0 if HARQ-ACK is not included in the PUCCH transmission.
O_{SR}(i) is a number of SR information bits. O_{SR}(i) is 0 if the SR is not included in the PUCCH transmission.
O_{CSI}(i) is a number of information bits of the Part 1 CSI report.
O_{CSI}(i) is 0 if the Part 1 CSI report is not included in the PUCCH transmission.

N_{RE}(i) is a number of REs (Resource Elements). For example,

$$\text{?} , where {N}_{sc , ctrl}^{RB} ( i )$$

$$\text{?} \text{indicates text missing or illegible when filed}$$

is a number of subcarriers per RB excluding sub-carriers for DMRS (Demodulation Reference Signal), and

$${N}_{s ymb - UCI , bfc}^{P U C C H} ( i )$$

is a number of OFDM symbols excluding symbols for DMRS for the PUCCH transmission occasion i on the active uplink BWP b of the carrier f of the primary cell c.

For a PUCCH transmission using PUCCH format 2 or PUCCH format 3 or PUCCH format 4 and for the number of bits of the first UCI larger than the predetermined number (for example, 11), the UE may determine the first parameter Δ_{TF,b,f,c}(i) based on the following Equation 3.

$${Δ}_{T F , b , f , c} ( i ) = 10 {log}_{10} ( {2}^{{K}_{2} \cdot BPRE ( i )} - 1 ) \qquad [ Equation 3 ]$$

where:
K2 is a constant, for example, K2=2.4

$$BPRE ( i ) = ( {O}_{ACK} ( i ) + {O}_{S R} ( i ) + {O}_{CSI} ( i ) + {O}_{CRC} ( i ) ) / {N}_{R E} ( i )$$

O_{ACK}(i) is a number of information bits for a HARQ-ACK codebook (for example, a number of HARQ-ACK information bits determined for the HARQ-ACK codebook (for example, Type-1 HARQ-ACK codebook and/or Type-2 HARQ-ACK codebook and/or Type-3 HARQ-ACK codebook)). O_{ACK}(i) is 0 if the HARQ-ACK is not included in the PUCCH transmission.
O_{SR}(i) is a number of SR information bits. O_{SR}(i) is 0 if the SR is not included in the PUCCH transmission.
O_{CSI}(i) is a number of information bits of the Part 1 CSI report. O_{CSI}(i) is 0 if the Part 1 CSI report is not included in the PUCCH transmission.
O_{CRC}(i) is a number of CRC bits of the first UCI. For example, O_{CRC}(i) may be a number of CRC bits of the Part 1 CSI report.

N_{RE}(i) is a number of REs. For example,

$$\text{?} , where {N}_{sc , ctrl}^{RB} ( i )$$

$$\text{?} \text{indicates text missing or illegible when filed}$$

is a number of subcarriers per RB excluding subcarriers for DMRS, and

$${N}_{s ymb - UCI , bfc}^{P U C C H} ( i )$$

is a number of OFDM symbols excluding OFDM symbols for DMRS for the PUCCH transmission occasion i on the active uplink BWP b of the carrier f of the primary cell c.

The method is simple to implement, can reduce the implementation complexity of the UE and the base station, and can ensure the reliability of the transmission of the HARQ-ACK, SR and Part 1 CSI report.

### Method MN5

According to some aspects of Method MN5, the related parameter of the reference bit sequence in Method MN3 may include a parameter (in embodiments of the disclosure, which may be referred to as a second parameter) indicating a minimum value of a number of UCI bits for power control (for example, for determining or obtaining the transmission power of the PUCCH). For example, the second parameter may indicate the minimum value of the number of UCI bits for power control when the number of UCI bits is smaller than or equal to the predetermined number (e.g., 11). In an example, Equation 2 in Method MN4 may be replaced by Equation 4.

$$[ Equation 4 ]$$

$${Δ}_{TF , b , f , c} ( i ) = 10 {log}_{10} ( {K}_{1} \cdot max \{ ( {n}_{H A R Q - A C K} ( i ) + {O}_{S R} ( i ) ) , {O}_{UCI , min} \} / {N}_{R E} ( i ) ) ,$$

where O_{UCI,min} is the second parameter. max { } is a maximum function. The definition of other parameters in Equation 4 may refer to the descriptions in Equation 2. The second parameter may be specified by protocols and/or configured by control signaling. For example, the second parameter may be included in the first information in Method MN1.

In some implementations, the UCI in the PUCCH may include two bit sequences, where the first bit sequence corresponds to a first UCI and the second bit sequence corresponds to a second UCI. For different numbers of bits of the first UCI, the second parameters may be separately specified by protocols and/or separately configured by control signaling. For example, according to whether the number of bits of the first UCI is larger than the predetermined number (e.g., 11), values of the second parameters may be separately specified and/or separately configured by protocols. The value of the second parameter when the number of bits of the first UCI is smaller than or equal to the predetermined number (for example, 11) may be different from the value of the second parameter when the number of bits of the first UCI is larger than the predetermined number (for example, 11).

In some implementations, the second parameter may be separately configured or specified by protocols for different HARQ-ACK codebook types. For example, the HARQ-ACK codebook types may include dynamic and semi-static. Or, the second parameter may only be configured or specified by protocols for the semi-static HARQ-ACK codebook. Or, only when the UE is configured with the semi-static HARQ-ACK codebook, the UE determines the transmission power of the PUCCH or determines the first parameter based on the second parameter.

In some implementations, the second parameter may be configured in case of multiplexing UCIs of different priorities in a PUCCH. For example, the UCIs in Equation 4 may all be UCIs of the higher priority, and O_{CSI}(i) may be 0.

This can avoid that the transmission power of the PUCCH cannot meet the reliability requirement of the HARQ-ACK of the lower priority when the number of HARQ-ACK information bits of the higher priority is larger than 0 and n_{HARQ-ACK}(i) of the higher priority is equal to 0 (or is smaller), and thus the reliability of the UCI transmission can be improved.

This method can ensure the reliability of each UCI transmission in the PUCCH based on a reasonable value of the second parameter (O_{UCI,min}). For example, in case that the UCI includes a Part 2 CSI report, this method can ensure the reliability of transmission of the Part 2 CSI report in the PUCCH by setting the value of the second parameter (O_{UCI,min}).

### Method MN6

According to some aspects of Method MN6, the UE is configured with the parameter related to UCI multiplexing with different priorities (e.g., the higher layer parameter uci-Mux WithDiffPrio), and is to transmit HARQ-ACK information bits of the lower priority, HARQ-ACK information bits of the higher priority and SR information bits of the higher priority (if any) in the PUCCH. The reference bit sequence in Method MN3 may be a bit sequence including a UCI of the higher priority. For example, the UCI of the higher priority may be the HARQ-ACK of the higher priority and/or the SR of the higher priority.

For example, the first parameter Δ_{TF,b,f,c}(i) may be determined as follows. Here, the first UCI includes the HARQ-ACK and/or SR of the higher priority.

For a PUCCH transmission using PUCCH format 2 or PUCCH format 3 or PUCCH format 4 and for the number of bits of the first UCI smaller than or equal to the predetermined number (for example, 11), the UE may determine the first parameter based on the following Equation 5.

$${Δ}_{T F , b , f , c} ( i ) = 10 {log}_{10} ( {K}_{1} \cdot ( {n}_{H A R Q - A C K} ( i ) + {O}_{S R} ( i ) ) / {N}_{R E} ( i ) \text{?} , \qquad [ Equation 5 ]$$

$$\text{?} \text{indicates text missing or illegible when filed}$$

where:
K1 is a constant, for example, K1=6.
n_{HARQ-ACK}(i) is a number of HARQ-ACK information bits of the higher priority for power control (for example, for determining or obtaining the transmission power of the PUCCH) obtained when the number of bits of the first UCI of the higher priority is smaller than or equal to 11. n_{HARQ-ACK}(i) is 0 if the HARQ-ACK of the higher priority is not included in the PUCCH transmission.
O_{SR}(i) is a number of SR information bits of the higher priority. is 0 if the SR of the higher priority is not included in the PUCCH transmission.

N_{RE}(i) is a number of REs (Resource Elements). For example,

$$\text{?} , where {N}_{sc , ctrl}^{RB} ( i )$$

$$\text{?} \text{indicates text missing or illegible when filed}$$

is a number of subcarriers per RB excluding sub-carriers for DMRS (Demodulation Reference Signal), and

$${N}_{s ymb - UCI , b f c}^{P U C C H} ( i )$$

is a number of OFDM symbols excluding OFDM symbols for DMRS for the PUCCH transmission occasion i on the active uplink BWP b of the carrier f of the primary cell c.

For a PUCCH transmission using PUCCH format 2 or PUCCH format 3 or PUCCH format 4 and for the number of bits of the first UCI larger than the predetermined number (for example, 11), Δ_{TF,b,f,c}(i)=10 log₁₀(2^{K}^{₂}^{·BPRB(i)}−1), where:
K2 is a constant, for example, K2=2.4

$$BPRE ( i ) = ( {O}_{A C K} ( i ) + {O}_{S R} ( i ) + {O}_{C R C} ( i ) ) / {N}_{R E} ( i )$$

O_{ACK}(i) is a number of information bits of a HARQ-ACK codebook of the higher priority. is 0 if the HARQ-ACK of the higher priority is not included in the PUCCH transmission.
O_{SR}(i) is a number of SR information bits of the higher priority. O_{SR}(i) is 0 if the SR of the higher priority is not included in the PUCCH transmission.
O_{CRC}(i) is a number of CRC bits of the first UCI.

N_{RE}(i) is a number of REs. For example,

$${N}_{RE} ( i ) = min ( {M}_{R B}^{P U C C H} \cdot {N}_{s c , c t r l}^{R B} \cdot {N}_{symb - {UCI}^{′}}^{P U C C H} ⌈ ( {O}_{A C K} ( i ) + {O}_{S R} ( i ) + {O}_{C R C} ( i ) ) / ( {Q}_{m} \cdot r ) ⌉ ) ,$$

$$where {N}_{sc , ctrl}^{RB}$$

is a number of subcarriers per RB excluding subcarriers for DMRS, and

$${N}_{s ymb - UCI}^{PUCCH}$$

is a number of OFDM symbols excluding OFDM symbols for DMRS for the PUCCH transmission occasion i on the active uplink BWP b of the carrier f of the primary cell c. r is a code rate of the first UCI of the higher priority. Qis a modulation order of the PUCCH.

The method is simple to implement, can reduce the implementation complexity of the UE and the base station, and can ensure the transmission reliability of the HARQ-ACK and SR of the higher priority.

In some implementations, the above Equation 5 may be replaced by the following Equation 6.

$$[ Equation 6 ]$$

$${Δ}_{TF , b , f , c} ( i ) = 10 {log}_{10} ( {K}_{1} \cdot max \{ ( {n}_{H A R Q - A C K} ( i ) + {O}_{S R} ( i ) ) , {O}_{UCI , min} \} / {N}_{RE} ( i ) ) ,$$

where, O_{UCI,min} is the second parameter configured in case of multiplexing UCIs with different priorities in a PUCCH. The definition of other parameters in Equation 6 may refer to the descriptions in Equation 5.

This can avoid that the transmission power of the PUCCH cannot meet the reliability requirement of the HARQ-ACK with the lower priority when the number of HARQ-ACK information bits of the higher priority is larger than 0 and n_{HARQ-ACK}(i) of the higher priority is equal to 0 (or is smaller), and thus the reliability of the UCI transmission can be improved.

### Method MN7

According to some aspects of Method MN7, determining the transmission power of the PUCCH or determining the first parameter (for example, in Methods MN4 to MN6) may further include determining the transmission power of the PUCCH or determining the first parameter based on a third parameter, where the third parameter is used to indicate whether the determination of the transmission power of the PUCCH or the determination of the first parameter is based on a number of bits of a HARQ-ACK codebook (for example, a number of HARQ-ACK information bits determined for the HARQ-ACK codebook (e.g., Type-1 HARQ-ACK codebook and/or Type-2 HARQ-ACK codebook and/or Type-3 HARQ-ACK codebook)). For example, the third parameter may be used to indicate whether to determine the transmission power of the PUCCH or to determine the first parameter based on the number of bits of the HARQ-ACK codebook or based on a number of HARQ-ACK information bits for power control (for example, for determining or obtaining the transmission power of the PUCCH). For another example, if the third parameter is configured, the transmission power of the PUCCH or the first parameter is determined based on the number of bits of the HARQ-ACK codebook. Otherwise, if the third parameter is not configured, the transmission power of the PUCCH or the first parameter is determined based on the number of HARQ-ACK information bits for power control (for example, for determining or obtaining the transmission power of the PUCCH).

In some implementations, if the third parameter indicates that the determination of the transmission power of the PUCCH or the first parameter is based on the number of bits of the HARQ-ACK codebook, the UE determines the transmission power of the PUCCH or determines the first parameter based on the number of bits of the HARQ-ACK codebook. For example, referring back to Equation 2 in Method MN4 and Equation 5 in Method MN6, in this case, n_{HARQ-ACK}(i) in Equation 2 and/or Equation 5 may be the number of bits of the HARQ-ACK codebook.

Additionally or alternatively, if the third parameter indicates that the determination of the transmission power of the PUCCH or the first parameter is based on the number of HARQ-ACK information bits for power control (for example, for determining or obtaining the transmission power of the PUCCH), the transmission power of the PUCCH or the first parameter is determined based on the number of HARQ-ACK information bits for power control (for determining or obtaining the transmission power of the PUCCH). For example, referring back to Equation 2 in Method MN4 and Equation 5 in Method MN6, in this case, n_{HARQ-ACK}(i) may be the number of HARQ-ACK information bits for power control (for example, for determining or obtaining the transmission power of the PUCCH) in Equation 2 and/or Equation 5. In an example, if the UE is configured with the third parameter, n_{HARQ-ACK}(i) may be the number of bits of the HARQ-ACK codebook when determining the transmission power of the PUCCH or the first parameter (for example, in Methods MN4 to MN6). Otherwise, if the UE is not configured with the third parameter, n_{HARQ-ACK}(i) may be the number of HARQ-ACK information bits for power control when determining the transmission power of the PUCCH or the first parameter (for example, in Methods MN4 to MN6). For example, for a semi-static HARQ-ACK codebook, the number of HARQ-ACK information bits for power control may be a number of received TBs or CBGs.

In another example, if the UE is not configured with the third parameter, n_{HARQ-ACK}(i) may be the number of bits of the HARQ-ACK codebook when determining the transmission power of the PUCCH or the first parameter (for example, in Methods MN4 to MN6). Otherwise, if the UE is configured with the third parameter, n_{HARQ-ACK}(i) is the number of HARQ-ACK information bits for power control when determining the transmission power of the PUCCH or the first parameter (for example, in Methods MN4 to MN6).

In some implementations, the third parameter may be separately configured or specified by protocols for different HARQ-ACK codebook types. For example, the HARQ-ACK codebook types may include dynamic and semi-static. Or, the third parameter may only be configured or specified by protocols for the semi-static HARQ-ACK codebook. Or, only when the UE is configured with the semi-static HARQ-ACK codebook, the UE determines the transmission power of the PUCCH or determines the first parameter based on the third parameter.

For the semi-static HARQ-ACK codebook, this method can avoid a case where the transmission power of the PUCCH is too low when DCI is missed, and can improve the reliability of the UCI transmission. At the same time, the flexibility of scheduling can be improved by configuring whether this method is triggered or not using a higher layer parameter.

### Method MN8

According to some aspects of Method MN8, determining the transmission power of the PUCCH or determining the first parameter (for example, in Methods MN4 to MN6) may further include determining the transmission power of the PUCCH or determining the first parameter based on a fourth parameter, where the fourth parameter is used to indicate whether the determination of the transmission power of the PUCCH or the determination of the first parameter is based on the number of bits of the Part 1 CSI report.

In an example, if the UE is configured with the fourth parameter, O_{CSI}(i) is the number of information bits of the Part 1 CSI report in Equation 2 or Equation 4 when determining the transmission power of the PUCCH or the first parameter (for example, in Methods MN4 to MN6). Otherwise, if the UE is not configured with the fourth parameter, O_{CSI}(i) may be a number of information bits of the Part 1 CSI report for power control (for example, for determining or obtaining the transmission power of the PUCCH) when determining the transmission power of the PUCCH or the first parameter (for example, in Methods MN4 to MN6).

In another example, if the UE is not configured with the fourth parameter, O_{CSI}(i) is the number of information bits of the Part 1 CSI report in Equation 2 or Equation 4 when determining the transmission power of the PUCCH or the first parameter (for example, in Methods MN4 to MN6). Otherwise, if the UE is configured with the fourth parameter, O_{CSI}(i) may be the number of information bits of the Part 1 CSI report for power control when determining the transmission power of the PUCCH or the first parameter (for example, in Methods MN4 to MN6).

In another example, it may be specified by protocols that O_{CSI}(i) is the number of information bits of the Part 1 CSI report for power control in Equation 2 or Equation 4.

For example, the number of information bits of the Part 1 CSI report for power control may be a sum of numbers of bits of a CSI reference signal resource indicator (CRI), a rank indicator (RI), a precoding matrix indicator (PMI), and a channel quality indicator (CQI). That is, the number of information bits of the Part 1 CSI report for power control may be a number of information bits of the Part 1 CSI report excluding padding bits (e.g., padded NACK bits).

The method can reduce the transmission power of the PUCCH, so as to reduce the power consumption of the UE and reduce the interference to other users.

### Method MN9

According to some aspects of Method MN9, the reference bit sequence in Method MN3 may be the first bit sequence or the last bit sequence of the two or more bit sequences. For example, the reference bit sequence may be a UCI bit sequence with a minimum (or maximum) UCI bit sequence index of the two or more UCI bit sequences.

The method is simple to implement, can reduce the implementation complexity of the UE and the base station, and can ensure the transmission reliability of the first bit sequence or the last bit sequence.

### Method MN10

According to some aspects of Method MN10, the reference bit sequence in Method MN3 may be configured by higher layer signaling and/or indicated by DCI. For example, the reference bit sequence may be configured as a certain/specific sequence by higher layer signaling.

This method is simple to implement and can improve the flexibility of scheduling.

### Method MN11

According to some aspects of Method MN11, the UE determining the transmission power of the PUCCH based on the first information or the UE determining the first parameter based on the first information in Method MN1 and/or Method MN2 may include the UE determining the transmission power of the PUCCH or determining the first parameter based on all bit sequences of the two or more bit sequences and/or the related parameters of all the bit sequences.

In some implementations, the first parameter corresponding to each of the bit sequences may be separately determined based on at least one of Methods MN4 to MN8. For example, for a bit sequence (any bit sequence) of the bit sequences, in the determination of the first parameter corresponding to the bit sequence (the any bit sequence), the reference bit sequence in Methods MN4 to MN6 may be replaced by the bit sequence (the any bit sequence). The transmission power of the PUCCH may be determined based on a maximum (or minimum) of the determined first parameter corresponding to each of the bit sequences.

In some implementations, the transmission power of the first PUCCH corresponding to each of the bit sequences may be determined separately based on at least one of Method MN3 to MN8. For example, for a bit sequence (any bit sequence) of the bit sequences, in the determination of the transmission power of the first PUCCH corresponding to the bit sequence (the any bit sequence), the reference bit sequence in Methods MN4 to MN6 may be replaced by the bit sequence (the any bit sequence). The transmission power of the PUCCH may be determined as a maximum (or minimum) of the transmission power of the first PUCCH corresponding to each of the bit sequences.

This method can ensure the reliability of the UCI transmission in the PUCCH.

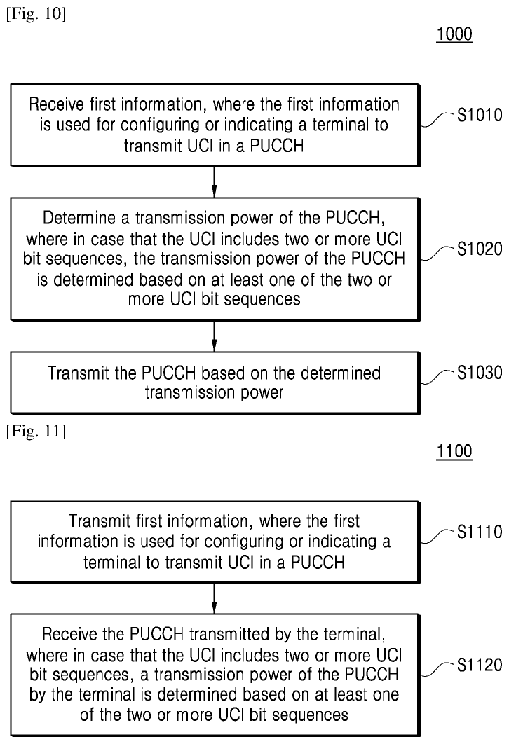

FIG. 10 illustrates a flowchart of a method 1000 performed by a terminal according to some embodiments of the disclosure.

Referring to FIG. 10, in operation S1010, the terminal receives first information, where the first information is used for configuring or indicating the terminal to transmit UCI in a PUCCH.

Next, in operation S1020, the terminal determines a transmission power of the PUCCH based on the first information. In case that the UCI includes two or more UCI bit sequences, the transmission power of the PUCCH is determined based on at least one of the two or more UCI bit sequences.

Then, in operation S1030, the terminal transmits the PUCCH based on the determined transmission power.

In some implementations, operations S1010 and/or S1020 and/or S1030 may be performed based on the methods described according to various embodiments of the disclosure (e.g., various methods/manners described above, such as in Methods MN1 to MN11).

In some implementations, the method 1000 may omit one or more of operation S1010 to S1030, or may include additional operations, for example, the operations performed by the terminal (e.g., UE) described according to various embodiments of the disclosure (e.g., various methods/manners described above, such as in Methods MN1 to MN11).

FIG. 11 illustrates a flowchart of a method 1100 performed by a base station according to some embodiments of the disclosure.

Referring to FIG. 11, in operation S1110, the base station transmits first information, where the first information is used for configuring or indicating a terminal to transmit UCI in a PUCCH.

Next, in operation S1120, the base station receives the PUCCH transmitted by the terminal, where in case that the UCI includes two or more UCI bit sequences, a transmission power of the PUCCH by the terminal is determined based on at least one of the two or more UCI bit sequences.

In some implementations, operations S1110 and/or S1120 may be performed based on the methods described according to various embodiments of the disclosure (e.g., various methods/manners described above, such as in Methods MN1 to MN11).

In some implementations, the method 1100 may omit one or more of operations S1110 to S1120, or may include additional operations, for example, the operations performed by the base station described according to various embodiments of the disclosure (e.g., various methods/manners described above, such as in Methods MN1 to MN11).

Those skilled in the art will understand that the above illustrative embodiments are described herein and are not intended to be limiting. It should be understood that any two or more of the embodiments disclosed herein may be combined in any combination. Furthermore, other embodiments may be utilized and other changes may be made without departing from the spirit and scope of the subject matter presented herein. It will be readily understood that aspects of the invention of the disclosure as generally described herein and shown in the drawings may be arranged, replaced, combined, separated and designed in various different configurations, all of which are contemplated herein.

Those skilled in the art will understand that the various illustrative logic blocks, modules, circuits, and steps described in this application may be implemented as hardware, software, or a combination of both. To clearly illustrate this interchangeability between hardware and software, various illustrative components, blocks, modules, circuits, and steps are generally described above in the form of their functional sets. Whether such function sets are implemented as hardware or software depends on the specific application and the design constraints imposed on the overall system. Technicians may implement the described function sets in different ways for each specific application, but such design decisions should not be interpreted as causing a departure from the scope of this application.

The various illustrative logic blocks, modules, and circuits described in this application may be implemented or performed by a general purpose processor, a Digital Signal Processor (DSP), an Application Specific Integrated Circuit (ASIC), a Field Programmable Gate Array (FPGA) or other programmable logic devices, discrete gates or transistor logics, discrete hardware components, or any combination thereof designed to perform the functions described herein. The general purpose processor may be a microprocessor, but in an alternative, the processor may be any conventional processor, controller, microcontroller, or state machine. The processor may also be implemented as a combination of computing devices, such as a combination of a DSP and a microprocessor, a plurality of microprocessors, one or more microprocessors cooperating with a DSP core, or any other such configuration.

The steps of the method or algorithm described in this application may be embodied directly in hardware, in a software module executed by a processor, or in a combination thereof. The software module may reside in a RAM memory, a flash memory, a ROM memory, an EPROM memory, an EEPROM memory, a register, a hard disk, a removable disk, or any other form of storage medium known in the art. An exemplary storage medium is coupled to a processor to enable the processor to read and write information from/to the storage medium. In an alternative, the storage medium may be integrated into the processor. The processor and the storage medium may reside in an ASIC. The ASIC may reside in a communication apparatus (e.g., a terminal or a base station). In an alternative, the processor and the storage medium may reside in a communication apparatus (e.g., a terminal or a base station) as discrete components.

In one or more exemplary designs, the functions may be implemented in hardware, software, firmware, or any combination thereof. If implemented in software, each function may be stored as one or more pieces of instructions or codes on a computer-readable medium or delivered through it. The computer-readable medium includes both a computer storage medium and a communication medium, the latter including any medium that facilitates the transfer of computer programs from one place to another. The storage medium may be any available medium that can be accessed by a general purpose or special purpose computer.

The above description is only an exemplary implementation of the present invention, and is not intended to limit the scope of protection of the present invention, which is determined by the appended claims.

1. A method performed by a terminal in a wireless communication system, comprising:
receiving first information, wherein the first information is used for configuring or indicating the terminal to transmit uplink control information (UCI) in a physical uplink control channel (PUCCH);
determining a transmission power of the PUCCH based on the first information; and
transmitting the PUCCH based on the determined transmission power, wherein in case that the UCI includes two or more UCI bit sequences, the transmission power of the PUCCH is determined based on at least one of the two or more UCI bit sequences.

2. The method according to claim 1, wherein in case that the UCI includes the two or more UCI bit sequences, the transmission power of the PUCCH is determined based on one UCI bit sequence of the two or more UCI bit sequences.

3. The method according to claim 2, wherein the one UCI bit sequence of the two or more UCI bit sequences is based on one or more of: a hybrid automatic repeat request-acknowledgement (HARQ-ACK) bit sequence; a scheduling request (SR) bit sequence; or a bit sequence of a Part 1 channel state information (CSI) report.

4. The method according to claim 2, wherein in case that the two or more UCI bit sequences include a first UCI bit sequence and a second UCI bit sequence, wherein the first UCI bit sequence includes a Part 1 CSI report and the second UCI bit sequence includes a Part 2 CSI report, the first UCI bit sequence is determined as the one UCI bit sequence.

5. The method according to claim 2, wherein the one UCI bit sequence of the two or more UCI bit sequences is a UCI bit sequence with a highest priority of the two or more UCI bit sequences.

6. The method according to claim 2, wherein in case that the two or more UCI bit sequences include a third UCI bit sequence and a fourth UCI bit sequence, wherein the third UCI bit sequence includes a UCI of a first priority and the fourth UCI bit sequence includes a UCI of a second priority, and wherein the first priority is higher than the second priority, the third UCI bit sequence is determined as the one UCI bit sequence.

7. The method according to claim 2, wherein determining the transmission power of the PUCCH based on one UCI bit sequence of the two or more UCI bit sequences includes:
determining a first parameter related to transmission power adjustment of the PUCCH based on the one UCI bit sequence; and
determining the transmission power of the PUCCH based on the determined first parameter.

8. The method according to claim 7, wherein the first parameter is determined further based on a second parameter,
wherein the second parameter indicates a minimum value of a number of UCI bits for power control, or the second parameter is configured for UCI multiplexing with different priorities and indicates a minimum value of a number of UCI bits for power control.

9. The method according to claim 7 or 8, wherein the first parameter is determined further based on a number of bits of a HARQ-ACK codebook when a third parameter is configured, wherein the third parameter indicates that the number of bits of the HARQ-ACK codebook is used to determine the first parameter.

10. The method according to claim 2, wherein in case that the UCI includes the two or more UCI bit sequences,
the transmission power of the PUCCH is determined based on a UCI bit sequence with a minimum UCI bit sequence index of the two or more UCI bit sequences, or
the transmission power of the PUCCH is determined based on a UCI bit sequence with a maximum UCI bit sequence index of the two or more UCI bit sequences.

11. The method according to claim 2, wherein the one UCI bit sequence of the two or more UCI bit sequences is configured by higher layer signaling and/or indicated by downlink control information (DCI).

12. The method according to claim 1, wherein in case that the UCI includes the two or more UCI bit sequences, the transmission power of the PUCCH is determined based on all of the two or more UCI bit sequences.

13. The method according to claim 12, wherein determining the transmission power of the PUCCH based on the first information includes:
determining first parameters related to transmission power adjustment of the PUCCH based on each of the two or more UCI bit sequences; and
determining the transmission power of the PUCCH based on a first parameter with a maximum value of the determined first parameters, or determining the transmission power of the PUCCH based on a first parameter with a minimum value of the determined first parameters.

14. The method according to claim 12, wherein determining the transmission power of the PUCCH based on the first information includes:
determining first transmission powers of the PUCCH for each of the two or more UCI bit sequences; and
determining a maximum value of the determined first transmission powers as the transmission power of the PUCCH, or determining a minimum value of the determined first transmission power as the transmission power of the PUCCH.

15. A method performed by a base station in a wireless communication system, comprising:
transmitting first information, wherein the first information is used for configuring or indicating a terminal to transmit uplink control information (UCI) in a physical uplink control channel (PUCCH); and
receiving the PUCCH transmitted by the terminal,
wherein in case that the UCI includes two or more UCI bit sequences, a transmission power of the PUCCH by the terminal is determined based on at least one of the two or more UCI bit sequences.
